(19) United States
(12) Patent Application Publication
(10) Pub. No.: US 2007/0176757 A1
(43) Pub. Date: Aug. 2, 2007

(54) Rat detection and monitoring system

(75) Inventor: Chan Hyuk Chyun, Seoul (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: CESCO CO., LTD., Gangdong-gu (KR)

(21) Appl. No.: 10/590,839

(22) PCT Filed: Feb. 28, 2005
(86) PCT No.: PCT/KR05/00561

§ 371 Date: Aug. 24, 2006

(30) Foreign Application Priority Data
Feb. 28, 2004 (KR) 10-2004-0013762

(51) Int. Cl. G06F 7/02

(52) U.S. Cl. 340/146.2

(57) ABSTRACT

The rat detecting apparatus is comprised of a sensor installed on a stick-shaped member that is set up at the edge of a building wall. The stick-shaped member projects from a wall of a building (or a dome-shaped member is installed on a ceiling). The rat detecting apparatus of the present invention can be configured according to the appropriate environment and space, and can be made into a module for easy installation.

### TECHNICAL FIELD

The present invention generally relates to a rat-detecting method and apparatus for detecting rats, and more particularly to a method and system for detecting rats using a rat detecting apparatus, which is designed in consideration of the environment, in order to control pests such as rats.

### BACKGROUND ART

Rats produce feelings of disgust to many people and can damage electrical wiring systems and the like. Thus, quick measures should be taken if any rats have appeared. Therefore, a system for detecting rats accurately, quickly and reliably is required.

Although many rat-detecting apparatuses have been proposed, the conventional ones are mostly in the forms of individual apparatuses and systems that do not consider the places of installation or the environment.

### DISCLOSURE OF THE INVENTION

The present invention is to provide rat-detecting sensor designed in consideration of unique characteristics of place of installment in order to solve the above-mentioned problems.

According to one embodiment of the present invention, the object of the present invention is to provide a rat detecting apparatus that can efficiently detect rats in a low-ceiling place.

According to another embodiment of the present invention, the object of the present invention is to provide a rat detecting and monitoring system using trespassing route of rats.

To achieve the above objects according to an aspect of the present invention, there is provided a rat detecting apparatus comprising a stick-shaped member, which can be installed at the corner of a building, having a plurality of sensors.

According to another embodiment of the present invention, the rat detecting apparatus is comprised of a stick-shaped member projecting from a wall of the building and multiple sensors installed on the stick-shaped member.

The above-mentioned stick-shaped member is comprised of more than two unit modules, each of which has one or more sensors attached thereon.

The rat detecting apparatus according to still another embodiment of the present invention is comprised of a dome-shaped member that can be installed on the ceiling part and multiple sensors installed on the dome-shaped member. According to another embodiment of the present invention, a rat detecting apparatus is comprised of a sensor, which faces downward and installed on a lower end of an inner wall of a building, in order to detecting objects passing on a floor.

Other characteristics and purposes of the present invention will be explained in detail below.

### BRIEF DESCRIPTION OF DRAWINGS

FIGS. 1 and 2 illustrate the principles of a rat detecting apparatus according to the first embodiment of the present invention.

FIG. 3 is an exemplary drawing that shows how the region detecting apparatus of line detecting type is used in practice.

FIG. 4 shows the region detecting apparatus of line detecting type installed in a real environment.

FIG. 5 shows an example of a rat detecting sensor installed in the space provided for electric wiring or at the ceiling.

FIG. 6 is shows details of a unit module of a stick-shaped sensor.

FIG. 7 shows the unit modules of the stick-shaped sensor stacked together.

FIG. 8 illustrates a dome-shaped sensor installed at the designated portion of a ceiling according to another embodiment of the present invention.

FIG. 9 illustrates a space detecting system using a sensor detecting sonic wave.

FIGS. 10 and 11 illustrate a tunnel-shaped rat detecting apparatus for precisely detecting the movements of the rats.

FIG. 12 illustrates the principles of the rat detecting apparatus according to another embodiment of the present invention.

FIG. 13 is an exemplary drawing of the detecting apparatus using height difference when it is installed on the wall.

FIG. 14 is another embodiment of the rat-detecting sensor to be installed on the wall.

FIG. 15 is a schematic diagram of the entire system, to which the detection signal by the rat detecting device is transmitted.

FIG. 16 is a schematic diagram showing the relationships among the rat detecting apparatus, repeaters, a remote control unit and a central control unit in accordance with an embodiment of the present invention.

FIG. 17 is a diagram showing an example of sectioning in accordance with an embodiment of the present invention.

FIG. 18 is a block diagram showing a remote control unit in a remote monitoring system of FIG. 15.

FIG. 19 is a block diagram showing a central control unit included in a remote monitoring system of FIG. 15.

FIG. 20 is a table showing the analysis of rats' activities in a sub-section.

FIG. 21 is an alarm table used by pest control timing decision module to decide when to proceed with the pest control measures.

FIG. 22 is an application table for selecting a table depending on a sub-section code.

FIGS. 23 and 24 are diagrams showing reports prepared by a central control unit of the remote monitoring system in FIG. 15.

FIG. 25 is a flow chart showing major operations of a remote control unit in the remote monitoring system.

FIG. 26 is a flow chart showing major operations of a central control unit in the remote monitoring system.

FIG. 27 is a schematic diagram of the remote monitoring system in accordance with an embodiment of the present invention.

FIG. 28 is a schematic diagram of the central control unit.

FIG. 29 is a schematic diagram of the remote monitoring system in accordance with another embodiment of the present invention.

FIG. 30 is a block diagram showing the remote control unit of the remote monitoring system in FIG. 29.

### BEST MODE FOR CARRYING OUT THE INVENTION

The embodiment of the present invention is directed to an improved rat detecting apparatus, as well as to a monitoring method and system using the same. Hereinafter, the rat detecting apparatus, monitoring method and system using the rat detecting apparatus will be explained in detail in view of the accompanying figures. The identical component in each figure is referred to using an identical reference number.

Rat Detecting Apparatus

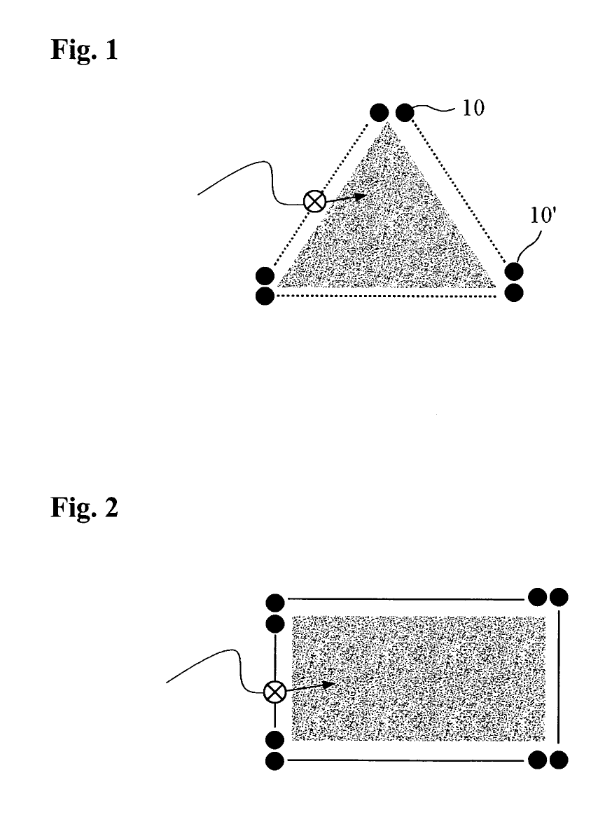

FIGS. 1 and 2 are drawings for explaining the principles of rat detecting apparatus according to the first embodiment of the present invention.

FIG. 1 explains the principles of the region detecting apparatus of line detecting type, which detects the periphery (side) of polygonal shaped region. The figure illustrates a triangular area where a set of line detecting sensor, which is comprised of light emitting unit 10 and light-receiving unit 10′, is placed at each side. If a sensor (light emitting unit and light-receiving unit) for detecting a passing rat is arranged on each side of the polygonal area as illustrated, the trespassing of a rat into the area can be detected as a result. FIG. 2 shows an example where the same principle is applied to a rectangular area.

The size of the area, which can be covered by the above-mentioned method, depends on the detecting capabilities of the sensor.

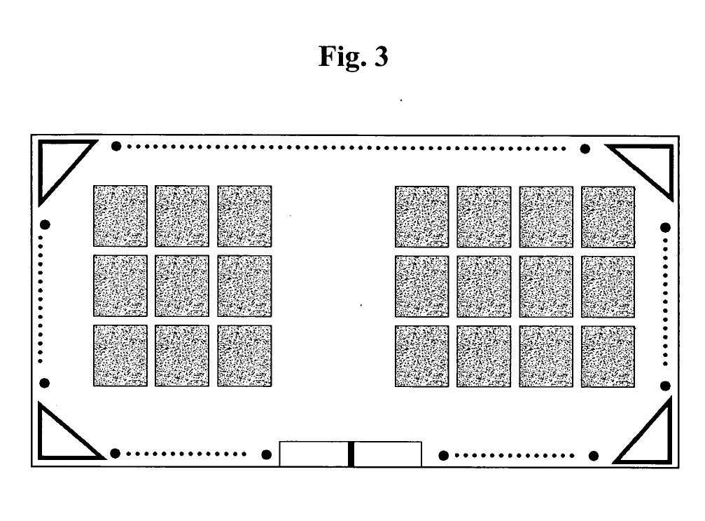

FIG. 3 shows how a region detecting apparatus of line detecting type is used in practice and illustrates a top view of a warehouse. By installing the region detecting apparatus (shown in FIG. 1) at the four corners of the warehouse, the movements of the rats along the walls can be detected. Since rats tend to move along the walls, it is likely that they will pass the triangular area illustrated in FIG. 3 when they pass the corner.

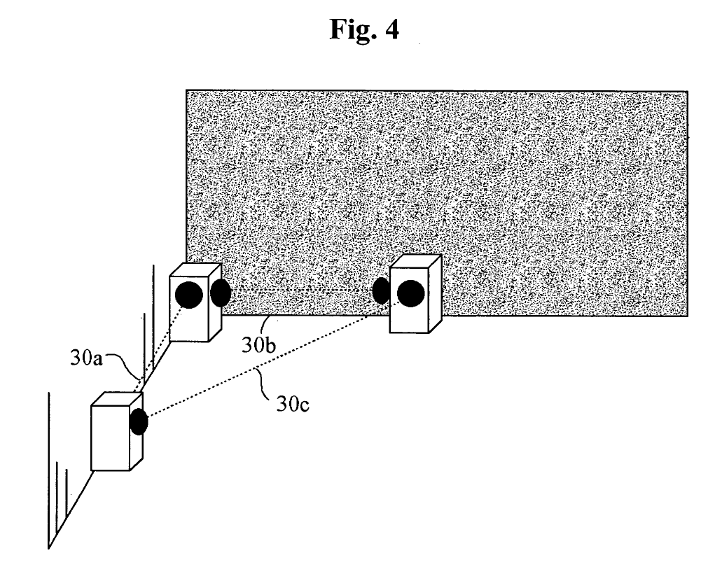

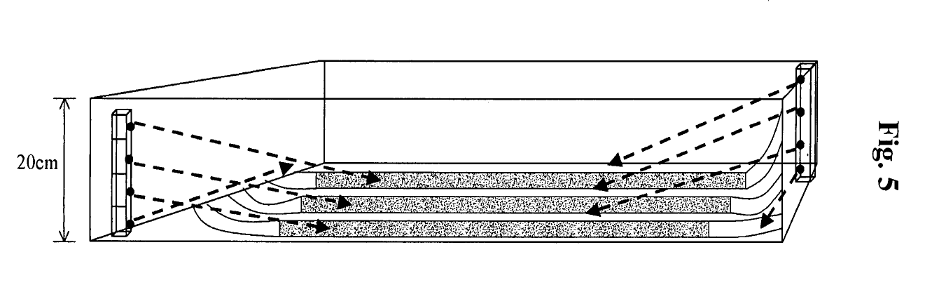

FIG. 4 shows the details of the region detecting apparatus of line detecting type of FIG. 3 installed in a real environment. A sensor is installed on stick-shaped members 20A, 20B and 20C that are projecting from the floor and have a predetermined height from the floor, wherein the height is decided based on the optimal detection of the rats. As illustrated in FIG. 4, each of the stick-shaped members 20A, 20B and 20C has one set of sensors (light-emitting unit and light-receiving unit) installed thereon and a set of sensors installed in neighboring stick-shaped members work together. The pair of sensors working together, (i.e., a pair of sensors at two ends of side 30A, 30B and 30C) is installed so as to face each other. The sensor pair at the ends of the side 30C, that is, the pair of sensors forming the hypotenuse of a right triangle should be installed so as to tilt 45 degrees from the wall. There can be many ways for installing the pair of sensors on a stick-shaped structure. For example, to readjust the direction of the sensor, one can install a socket on a stick-shaped structure for attaching a sensor that can adjust direction of the sensor. In a region detecting apparatus having the configuration shown in FIG. 4, the apparatus can be configured to detect the triangular area that has the side length from tens of centimeters up to a meter. The size of the detected area can be set based on the size of the entire place, possible detecting range of a sensor, etc. The accuracy of detection according to the size of area can be affected by the type or capacity of the sensor, accurate readjustments of direction in installation, ambient illumination intensity, etc.

FIG. 5 shows an example of a rat detecting sensor installed in the space for electric wiring or at the ceiling. Generally, the electrical wiring of a building is placed at the ceiling or floor. This wiring space is fairly a small space (e.g., tens of centimeters), but is very important in terms of pest control since the electrical wires disposed therein can be seriously damaged by the rats. Also, wiring, pipes or ceiling of a building are main routes for rats. Therefore, controlling the pests at the ceiling is very crucial for performing pest control of the entire building.

In such places of low height, the stick-shaped rat detecting sensor can be used. The stick-shaped sensor illustrated on FIG. 5 shows the module with one or more sensors piled up on each other. The stick-shaped sensor in an embodiment of the present invention is an infrared light sensor for detecting infrared light from living creatures. Such senor can detect from a distance of up to a meter. Although the detecting range is limited compared to the entire area, if the sensor is arranged at the corner of a wall, the possibility of detecting a rat is high since the rats have the tendency to move along the walls. If the place is spacious, the stick-shaped sensor can be additionally placed between the corners. In addition, the sensor for detecting rats in the present invention is not limited to the above-mentioned infrared light sensor of a meter range, but can include sensors of various functions and capacity that can detect the movements and existences of rats. For example, an infrared light sensor that can detect the movement of an object, which is similar to the type used for detecting burglary, can be also adopted for rat detecting.

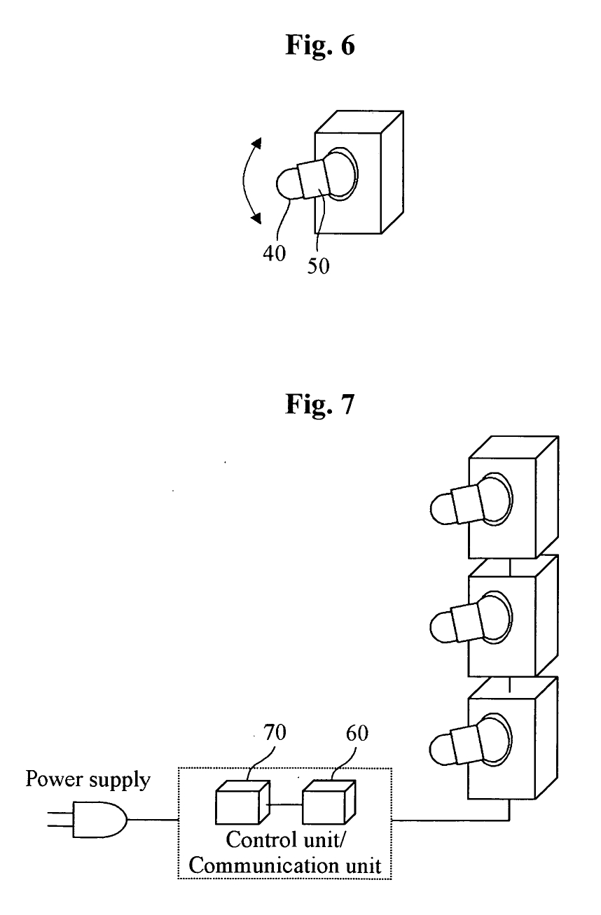

FIG. 6 shows the details of a unit module of a stick-shaped sensor. The stick-shaped sensor is made by installing socket 50 for attaching the conventional sensor 40 to the stick-shaped unit module such that the direction of sensors can be adjusted. The socket 50 enables the sensor to move up, down, right and left. Referring to FIG. 5, by adjusting the direction of the sensor, the sensor is adjusted to detect a desired area. When installed in real environment, the direction of each sensor should be arranged such that each sensor detects a different non-overlapping region. In addition to what is illustrated in FIG. 6, various structures for adjusting the sensor can be used. For example, sensors can be attached to resilient wire and then by bending the wire, the direction of the sensors can be changed. Alternatively, the sensor can be fixed (and not changing direction) once it is attached to the module, in which sensor modules in various directions are made as needed.

In the structure using the socket 50, the socket can be configured so as to be directed in one of many directions such that the sensor 40 cannot rotate or move to an arbitrary direction (i.e., only discrete movement is possible). By configuring the socket as explained above, it is easy to distinguish the direction of the sockets. Thus, it becomes convenient to put each sensor in different directions when a number of them are installed.

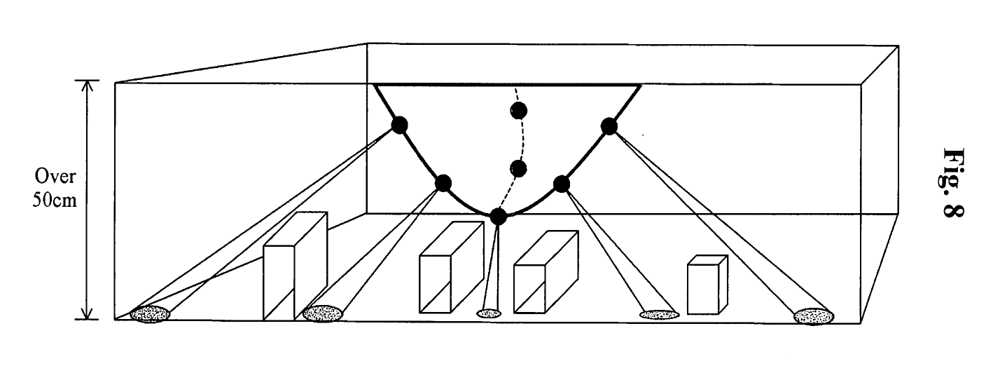

The unit sensor module can be stacked vertically (as seen in FIG. 7). In the figure, the lengths of the unit sensor modules are the same. However, a longer module and a dummy module, that is, a module without a sensor, can be used to adjust the height of the entire stick-shaped sensor, as needed. Preferably, each stick module has a space inside the module through which electrical wiring passes. Otherwise, the electrical wiring can only be mounted on the surface of the module. A control unit 70, a communication unit 60 and a power supply 80 are connected at the end of the stick-shaped modules installed physically in one place. The control unit 70 controls the operation of each sensor and processes the input values from the sensor. The communication unit 60 communicates, either in wired or wireless mode, the detection value from the sensor unit or the processed value from the control unit. The power supply 80 provides power to the module and uses the power supplied from homes, factories or batteries. The sensor and the control unit 70 can be connected by wire using the space inside each module (not shown). The control unit 70 and the communication unit 60 could be put in a small separate box or could be placed in a vacant space inside the stick-shaped module that is near the floor. Up to now, all the figures show one sensor for each stick-shaped module. However, depending on the design, more than two sensors can be installed and sensors installed in a module can face the same or different directions.

FIG. 8 is a drawing of a dome-shaped sensor installed at the ceiling part of a designated space according to another embodiment of the present invention. The apparatus of dome-shape has many sensors, which are spaced apart from each other, on the surface of the dome. A sensor covers a designated angle area such that the multiple sensors can cover the entire space where the dome is installed. FIG. 8 illustrates a dome with nine sensors installed thereon. The number of sensors should be decided depending on the size and height of the detecting area, the sensitivity of the sensor, and the size of the dome-shaped structure. In addition, the shape of the dome can be modified. For covering wide and complicated area with many structures on the floor, a leveled down dome is more appropriate, whereas for narrow area with high ceiling, a sharpened dome is more appropriate. The dome-shaped sensor apparatus should be installed in a space higher than tens of centimeters considering the height of the dome itself. As with the stick-shaped sensor, each sensor attached to the dome-shaped structure can be made to change its direction. The socket configuration explained above can also be used to attach the sensors. By adjusting the directions of the sensors when installing them in the real environment, the optimal detecting capability can be sought. For example, in cases where obstacles are on the floor, the sensor could be adjusted to detect the area that includes the route which the rat is likely to move along to avoid the obstacle.

It is also possible to arrange the previously mentioned stick-shaped sensor and dome-shaped sensor in a same place to cover different areas. Also, as previously mentioned, the dome-shaped sensor can be made using conventional movement sensor. Instead of setting up multiple sensors, a sensor could rotate to scan the space.

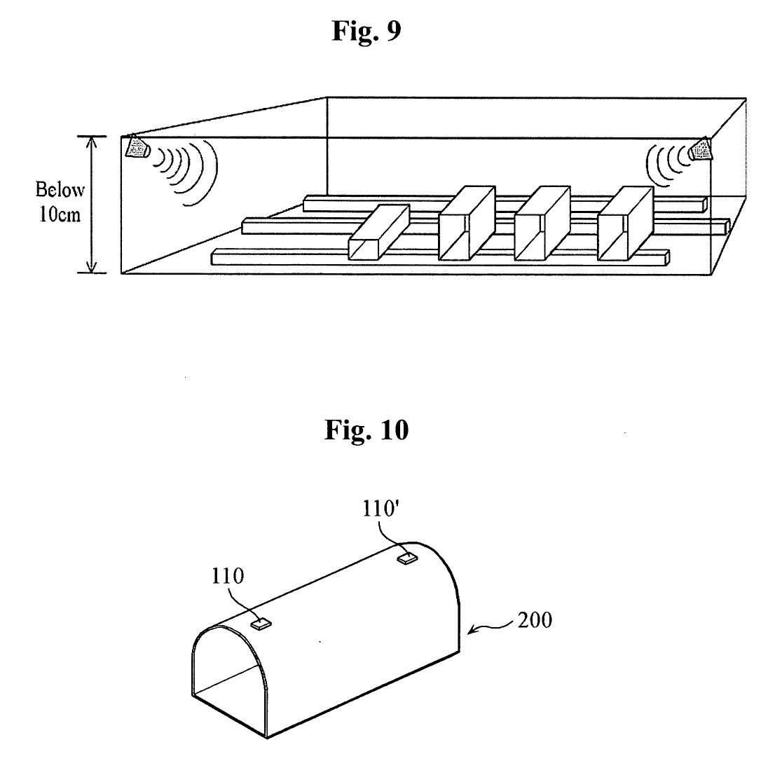

FIG. 9 is a drawing of a space detecting system using a sensor detecting sonic wave. The sonic wave sensor detects the rat by transmitting sonic wave and receiving it back, and detecting the difference of the received sonic wave values between the normal state with no rats and the state when rats exist. It is using the principle that the reflection of the sonic wave differs when an object is in motion. A number of sonic wave sensors can be installed at corners of the wall as illustrated. This method is appropriate for places where there are no people or no noise of electrical device, that is, where there does not exist any factors for fluctuation in sonic wave.

Hereafter, the method for detecting rats with previously described sensors will be briefly explained. When using the infrared light sensor or light-emitting/light-receiving sensor, the absolute threshold for rat passing and passing is not set. Rather, comparative criteria is used to determine whether or not the rat exists by comparing the values when the rat passes and does not pass. For example, one can measure the detection value several times when rats do not exist and set the value as a standard. Then, if the sensor value departs from the standard value by certain range, it can be decided that rats have appeared. The range can be determined through tests.

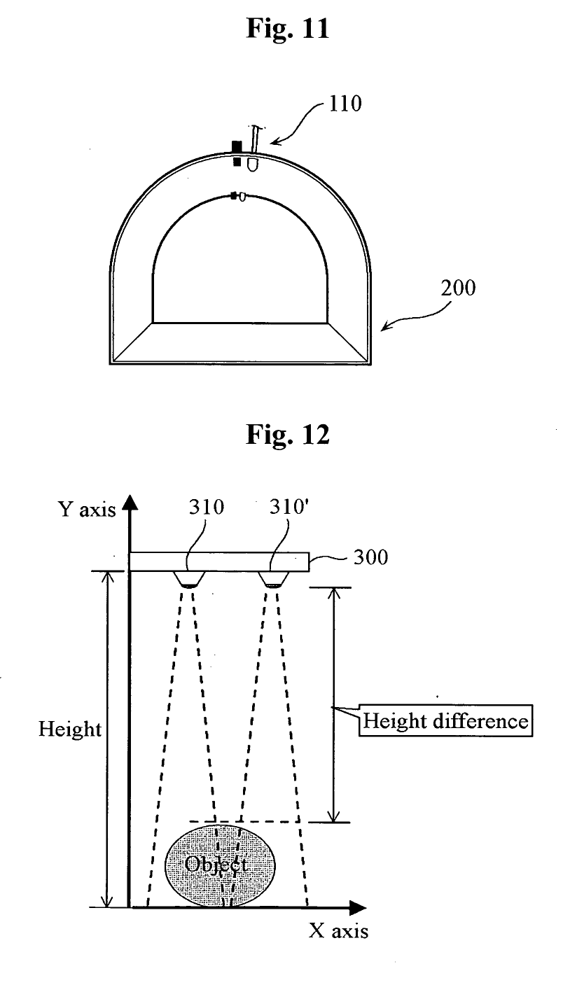

FIGS. 10 and 11 are diagrams of a tunnel-shaped rat detecting apparatus 200 for precisely detecting the movement of the rat. FIG. 10 is perspective view of the tunnel-shaped rat detecting apparatus and FIG. 11 is a front view of the same. The tunnel-shaped rat detecting apparatus is installed near the wall where rats frequently appear. The tunnel-shaped rat detecting apparatus is composed of a conventional tunnel-shaped mousetrap with birdlime having additional detecting sensors 110, 110′. It is preferable to install the mousetrap near the wall where the rats often pass and/or place where the rats may freely access through both ends of the mousetrap. Sensors of the tunnel-shaped rat detecting apparatus 200 operate in a controlled space (i.e., predetermined space of known height and color). Thus, the possibility of detecting a rat is very high. Also, information such as the direction of the rat can be obtained and as such, information related to the paths of rats or the habitat can be provided. The apparatus can perform the functions of detecting and catching rats at the same time by placing baits to attract rats and by installing birdlime to catch rats in the interior of the tunnel-shaped rat detecting apparatus.

A cross section of the tunnel-shaped rat detecting apparatus is in the shape of an arch (as shown in FIG. 10). However, it can be modified into various forms. For example, the cross-section can be in polygonal forms such as rectangular, triangular or diamond-shaped. In case of the rectangular section, it can be configured to be fixed to one side of the wall. Further, the rat detecting apparatus can be made not only in form of a tunnel, which the interior is open for access, but also in the form of a box, which had more than two holes for entrance and exit. The box-shaped rat detecting apparatus 200 may have sensors at the entrance and the exit to detect the movements of the rats similar to the tunnel-shaped rat detecting apparatus. Also, baits can be placed inside the box to attract rats. Capturing devices, such as birdlime or mousetraps, can be installed inside as well.

As illustrated in FIGS. 10 and 11, the detecting sensors 110 and 110′ are installed a little bit a part from the ends of the top of the body. The detecting sensors could be a pair of sensors comprised of a light-emitting unit and a light-receiving unit, the aspect of which will be explained below in view of FIG. 12. The detecting sensors 110 and 110′ are installed so as to be apart from the edge of the tunnel-shaped body. This is so that the sensors do not malfunction when people or things pass by, while detecting rats only when the rats are sufficiently inside the tunnel. Further, by installing one pair of sensors near both edges of the tunnel-shaped mainframe, the behaviors of rats (e.g., directions of the entrance and exit of rats, the stay time in the tunnel, etc.) can be determined by detecting which sensor had detected the rat first and for which period of time each sensor detected the rats.

When the rat passes the tunnel-shaped frame, the sensors can receive a number of inputs from one rat. For instance, sensor can perceive the head, body and tail of a rat as constituting different rats. In addition, if a rat wanders around the sensor near the entrance of rat detecting apparatus, stays a long in the tunnel while moving around, or moves its tail after entering the device, it can be recognized as multiple rats. To prevent a single rat from being perceived as many rats, the detection result during a predetermined period (related to an average time of a rat's stay in the tunnel) could be considered as one rat. The time a rat stays in a tunnel can change depending on various factors. For instance, environmental factors (e.g., temperature) or other factors (e.g., baits inside the apparatus) can change the length of rat's stay.

A specific example of calculating the number of times the rats pass the tunnel-shaped rat detecting apparatus is explained as follows. When determining the number of rat appearance in rising edge count method, the number of rat detection is increased by one at a time when a rat starts to be detected and before which the rat was not detected. The time when the rat starts to be detected is determined to be the time when the sensor value starts to depart from a steady state value (sensor value when there are no rats) by more than a predetermined threshold value. The time when such value is detected for the first time by either of the sensors, which are at both ends of the tunnel, is determined as the time when a rat has entered the tunnel towards the corresponding sensor. For a more precise detection, it may be determined that the rat has invaded only when the difference of sensor value remains to be larger than the threshold for predetermined time. This method will alleviate the possibility of false alarm being caused by a temporary wrong value that results from noise occurring in the sensor or a related circuit.

Furthermore, the apparatus can be programmed not to increase the detected frequency (or to stop detecting) for a predetermined time once a rat is detected, that is, after the detected number is increased by one, in order to prevent the same rat from being sensed several times.

Occasionally, rats can stay in the tunnel-shaped rat detecting apparatus for a long time. In this case, the above simple algorithm of not increasing the detected number for a predetermined time has possibilities of counting one rat multiple times. To prevent this, once a rat is detected, the rat detecting algorithm can wait until it is decided that the rat comes out of the tunnel completely before resuming the detection operation. Specifically, one method of determining whether or not a rat has exited the tunnel-shaped detecting apparatus completely is to confirm neither of the two sensors, which are at the ends of the tunnel, generates a rat detection signal (i.e., value higher than steady-state value by a threshold or larger) for a predetermined time. In case the rat detection algorithm starts again after the state of no rat is maintained for a predetermined time, the possibility of counting a rat more than once is low even if the rat stays inside the tunnel-shaped rat detecting apparatus for a long time.

As shown above, the rat activity patterns can be obtained by analyzing the values inputted into the sensor by a rat. For example, if the left sensor signals the detection of a rat and then the right sensor detects the rat wherein a little later the sensor determines that there is no rat in the apparatus, this means that a rat has entered the apparatus from the left and exited to the right. More particularly, the data such as the place of frequent appearance and the direction of the invasion of rats may be derived and predicted for the entire building or per small section by placing the tunnel-shaped rat detecting apparatus at many places around the building and analyzing the frequency and the direction of the rat from each rat detecting apparatus. For instance, if the rats are frequently detected in a particular location (e.g., near a certain entrance, a pipe hole or a passage of a radiator), then the related entrance or passage can be the primary factor for rat appearance.

FIG. 12 is a diagram that explains the principles of the rat detecting apparatus according to another embodiment of the present invention. When sensors (light-emitting unit and light-receiving unit 310 and 310′) facing downward are installed at a predetermined height from the ground, the sensors can distinguish between the ground and the passing object, thereby detecting the object. This is based on the fact that when an object passes by, light is reflected from a surface that has a height difference from the ground and such reflected light is received by the sensor. As illustrated in FIG. 12, rats, which move along the walls, can be effectively detected by attaching a stick-shaped member 300 with sensors to the side wall. The number of sensors, location of installation in direction of X and height of Y direction may influence the performance of the rat detection. Such values should be decided based on the characteristic of the sensors (i.e., the covering angle of the sensors) or the size of the rat. An experiment may be conducted to decide the optimum condition for detection by observing the sensor output as the sensor is adjusted in height and location using an imaginary object to decide proper positioning of the sensors. The present invention has used CL-1L5R as the light-emitting unit, ST-1KLA as the light-receiving unit and a 4 cm cube for an object to be detected in order to conduct an experiment. The results show that the appropriate height for detecting the rats is within about 10 cm. The sensors, which are appropriate for the embodiment of FIG. 12, are not limited to such sensors, but can be any sensors that can detect the rats passing under the sensor by using the height between the ground and rat or by other types of methods.

A specific method for detecting whether or not a rat is passing below is as follows. If the difference between the sensor value and a steady-state value is over a predetermined threshold, then it is decided that a rat passes below. In addition, as explained above, the rising edge count method can be used to increase the number of rat appearances at the time when a rat starts to be detected. As explained with respect to the tunnel-shaped rat detecting apparatus, the same method for preventing a same rat from being counted several times can be applied. More specifically, the rat detecting algorithm may be stopped for a predetermined time after a rat is detected or at the same time the rat detecting algorithm starts only after confirming that there is no detection of rats for a prescribed time.

The steady state value is not one single constant value, but may change depending on the ambient light or arrangements of the furniture. Thus, the steady state value should be updated periodically or should be standardized by other methods in order to obtain accurate results. Also, the threshold value, which is the standard for determining whether or not a rat is detected, is adjusted or standardized depending on, for example, the lighting conditions. In an environment where light changes regularly on the basis of a day, a timer may be built-in to the control circuit to change the steady state value and threshold according to time. However, if more precise control is needed or the light of the environment changes without any regularity, the value of the steady state and threshold may be adjusted by using the measured value of surrounding light.

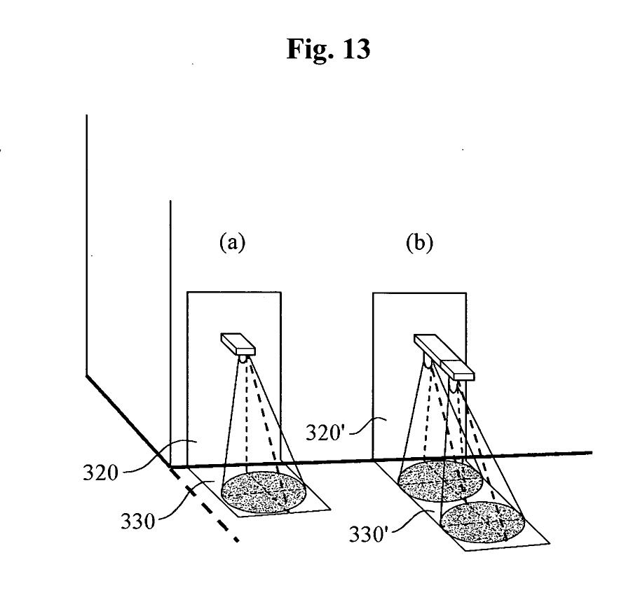

The color of the floor, which the sensor is directed to, may influence the performance of the sensor. According to the experiment, the sensor functions well when the color of the floor is white. Therefore, the rectangle marked on the floor 330 and 330′ and sidewall 320 and 320′ in FIG. 13 may be colored white to enhance the detecting capability and may be integrated with the sensor module to be implemented as one apparatus. More specifically, the integrated floor part, sidewall part and the sensor module may be installed on the wall as a unit device.

FIG. 13 is an exemplary drawing of the detecting apparatus using the height difference in FIG. 12 when it is actually installed on the wall. FIG. 13(a) shows a case in which only one sensor is installed. FIG. 13(b) shows a case in which two sensors were made as a module to broaden the detection area. Similar to the stick-shaped sensor of FIG. 7, the height difference sensor of FIG. 13 may become modular so as to be extended by fitting the modules together. A rat, which passes by away from the sensor, may also be detected under the constitution of FIG. 13(b). If the sensors are made modular so as to be connected with each other, the wiring between the control apparatuses related to the sensors may be placed inside the stick. Also, the electrical control apparatus for detecting, storing and processing the sensor value and operating the sensor may be made as a separate apparatus and be installed on the wall near the sensor of the detecting device. Alternatively, it can be installed inside the module that is nearest to the wall.

If the floor part and the sidewall part is integrated with the height difference sensor, the floor part and the sidewall part should be firmly attached to the floor and the wall using a two-sided tape, nail or other connection means. This prevents the change in direction of the sensor when rats or people accidentally bump into the sensor module. In the embodiment where the floor part and the sidewall part are not integrated with the sensor, a horizontal stick is installed directly to the sidewall. Alternatively, a vertical stick may be installed to attach the horizontal stick (in this case the supporting structure that has the “□” shape) thereto. When using “□” shaped structure, the vertical stick could be configured such that the horizontal stick may be attached to the vertical stick at more than two places (or continuously) (i.e., the height of the horizontal stick could be adjusted).

In the same manner, the positioning of the sensor on the horizontal stick may be adjusted. In particular, multiple sensor holding sockets may be installed on the horizontal stick so that sensors can be placed on the appropriate location according to the circumstances. Otherwise, an extended adjusting groove may be carved out on the horizontal stick so that the sensor is installed in the grove while changing its position continuously. However, although the horizontal stick or sensor may change its positions, once its position is set, the stick and the sensor should be firmly attached so that it does not move easily due to an external force.

In any case, the situation in which a person or an object collides with the projecting horizontal stick should be considered. More specifically, it is preferable to shorten the length of the stick and install the sensors out of the track of people to fundamentally lower the possibility of people approaching the sensors. In addition, a protective device or a notice may be placed to lessen the possibility of a person colliding with the sensor. The projecting horizontal stick may be attached to the wall in an elastic manner so that the stick temporarily bends and comes back to its place when a person collides with the stick. For example, an elastic material may be inserted into the part of the horizontal stick that is attached to the wall, vertical stick or vertical sidewall part. Alternatively, the projecting horizontal stick may be made of elastic material. A method, which does not use an elastic material, is also possible. For example, when an impact is applied to the horizontal stick in a horizontal direction, the stick can be folded toward the wall instead of continuing to receive the force. With such structure, the detecting device and people will not be damaged or injured even when they collide into each other.

Another method is installing a separate structure for covering the entire projecting stick (e.g., a structure similar to the “L” shaped structure formed by the floor part and the sidewall part in FIG. 13(b), with the structure being turned upside down). In this case, an object that is passing by is less likely to be detected and the system will be influenced less by the external surroundings. Thus, the operation of the detecting apparatus will be more stabilized. In addition, since the cover creates an enclosed space, the apparatus will have the similar attraction for rats as the previously explained tunnel-shaped rat detecting apparatus.

By installing more than one height difference rat detecting apparatus of FIG. 13, the degree and direction of rat activity may be monitored. In particular, similar to the principles of the tunnel-shaped rat detecting apparatus, the direction of the rat movement may be determined by considering the relative detection time between the two rat detecting apparatus. In addition, the direction of the rat may be estimated using the modified embodiment of the detecting apparatus illustrated in FIG. 12 or 13. In the modified embodiment, the width of the stick-shaped horizontal projecting unit of the detecting apparatus is predetermined and the two rows of sensors are placed apart from each other (i.e., 2*2 sensors in case of FIG. 13(b)). In this case, by using the gradient of the measured values from the two rows of sensors, the direction of the rat may be determined. More specifically, the moving direction of the rat may be determined by detecting which sensor first outputs a value over the threshold.

One use of the height difference rat detecting apparatus is to monitor the flow of rats through the entrance or other invasion route such as pipelines or heating installations by placing the apparatus near such entrance or route. The height of the rat detecting apparatus may be decided by considering the location of the entrance door.

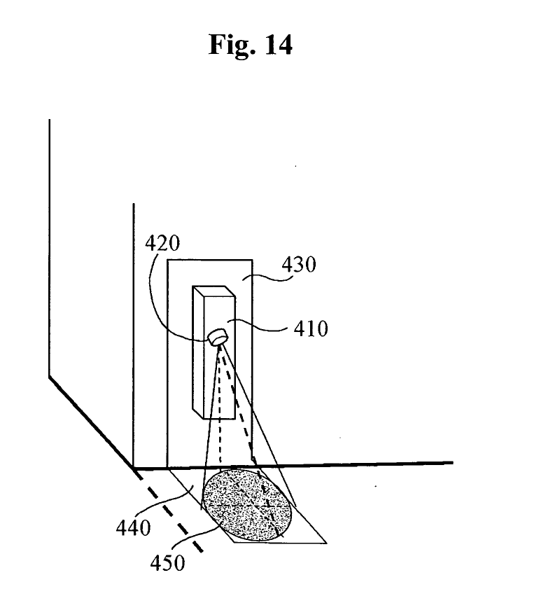

FIG. 14 shows another embodiment of the rat-detecting sensor, which is to be installed on the wall. The sensor of FIG. 14 is installed on the sidewall facing down the floor with an inclination (“inclined type”) and detects the movements of the rats in the area where the sensor is directed. In case of the embodiment of FIG. 14, if the angle of the sensor from the vertical direction is less than a predetermined value (i.e., the direction of the sensor is almost vertical), the sensor provides a better performance. Also, according to the test result, the higher the height of the sensor is, the sensor direction should be nearer to the vertical direction to achieve satisfactory performance. When using a light sensor as previously explained, the preferable height is 5 to 10 cm and the angle should be less than 45 degrees from vertical direction.

The inclined type sensor of FIG. 14 operates using the same principles as the height difference sensor of FIG. 13 except that the horizontal stick does not need to be installed due to the angle. Therefore, most of the corresponding explanations on FIGS. 12 and 13 applies to the same.

In particular, similar to FIGS. 12 and 13, the rat is detected if the difference between the value of steady state without a rat and the sensor value is over a predetermined value (threshold). Also, by using the rising edge detecting method, the number of rat appearances can be increased at the time when an object starts to be detected, which is considered as the time when the rat passes by. As explained previously with respect to the tunnel-shaped rat detecting apparatus, identical methods can be applied in order to prevent one rat from being counted as multiple rats.

The value of the steady state is not a set value and may be changed according to the lighting of the room or arrangement of the nearby furniture. Therefore, the steady state value should be updated regularly or standardized by using other methods to obtain accurate results. Similarly, the value of threshold, which is the basis for determining whether or not the rat has been detected, may be adjusted or standardized according to the lighting condition. In an environment where light changes regularly on the basis of a day, a timer may be built-in to the control circuit to change the steady state value and threshold according to time. However, if more precise control is needed or the light of the environment changes without any regularity, the steady state value and the threshold may be adjusted by using the value measured from the surrounding light.

The floor part 440, which the sensor is directed to, is colored in white and is integrated with the sensor module to enhance the detecting capability. More specifically, the floor part 440, sidewall part 430 and sensor module 410 and 420 are integrated as a one unit device to be installed on the wall.

In addition, the movement directions of the rats can be monitored by installing more than two sensors of FIG. 14 and similar algorithm may be adopted to prevent a same rat from being counted multiple times.

The vertical stick member 420 for attaching the sensor may be configured to install sensor(s) in discrete positions or continuously and such member may include the wires or other electrical device therein. Also, the sensors may be attached to the vertical stick member 420 using sockets and the angles of the sockets may be adjusted to provide different angles to the sensors.

When installing the previously explained rat detecting apparatuses in a real site, the electrical power is provided to apparatuses in operation for more than a predetermined period of time on a regular basis and batteries are used for apparatuses that are used for a short amount of time. The apparatuses using batteries need a battery carrier and a power line in addition to the above-explained elements. The apparatus using the battery can be conveniently used without wire connection when the number of rat appearances suddenly increases or when a temporary apparatus is needed for on-site inspection.

The above explained detecting apparatus may include a communication module that transmits detected data to a control device installed on site or at a remote location. The communication module can be either a wired or wireless type, and several detecting apparatuses may be grouped together for the communication.

When a rat is detected in the detecting apparatus in an embodiment of the present invention, the situation is considered as an emergency and a warning message is sent to the remote monitoring center and to a responsible service technician. For example, the monitoring center can have a system for sending a short message service to the service technician when a rat is detected. This is so that immediate pest control measures can be taken. The system to perform pest control/monitoring by using the data from detecting apparatus is explained below.

Remote Rat Monitoring Method and System for the Rat

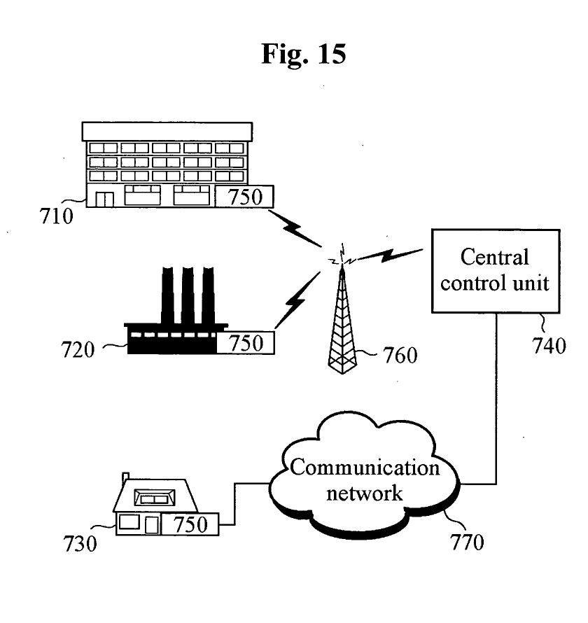

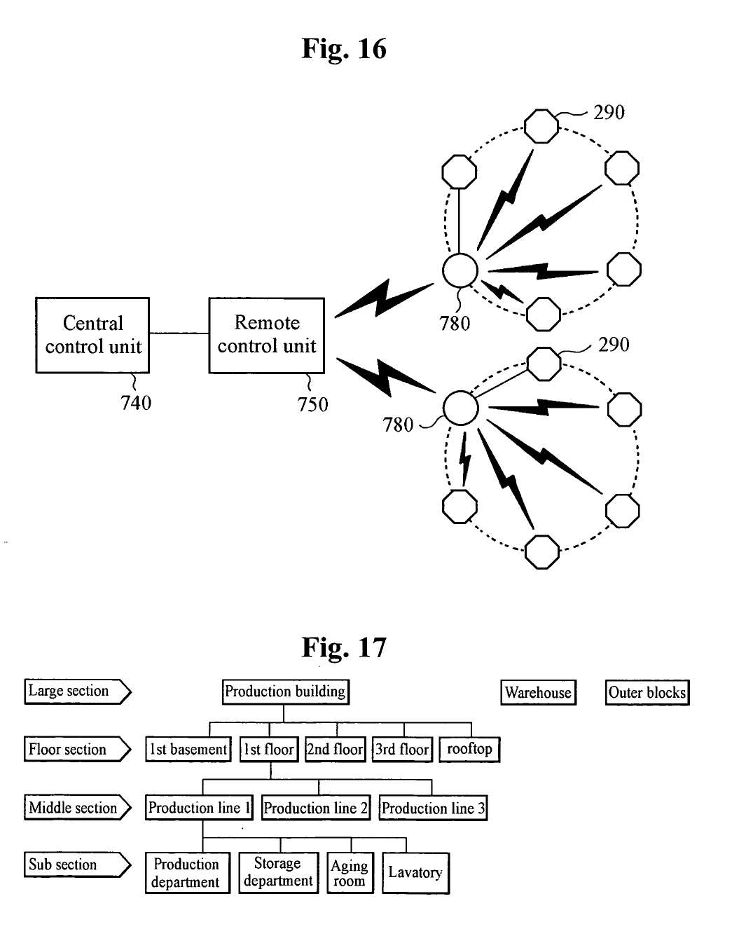

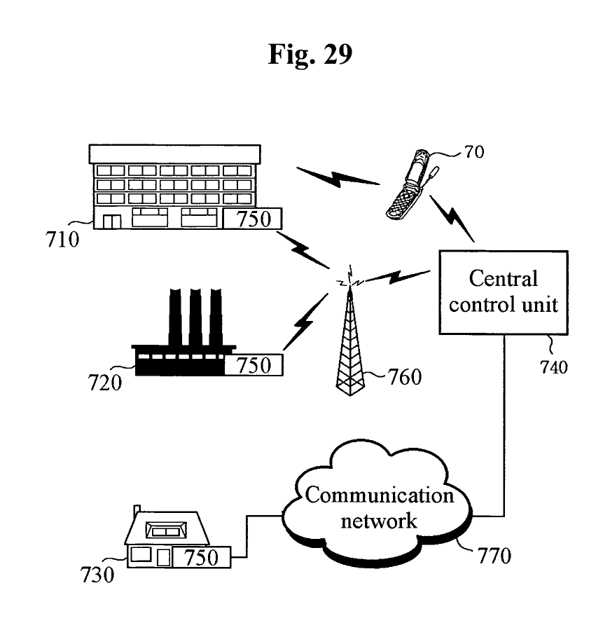

Referring to the FIG. 15 through FIG. 30, the remote monitoring system, which can monitor the activities of rat from remote places using the rat detecting apparatus with the sensor, will be explained. The rat detecting apparatus in FIGS. 15-17 includes not only the ones explained above but also other various apparatuses.

FIG. 15 is a schematic diagram conceptually illustrating the remote monitoring system for pest control according to the first embodiment of the present invention.

As illustrated therein, the remote monitoring system for pest control according to the embodiment of the invention includes the remote control unit 750, which is installed in a monitored subject site such as a building 710, 720 and 730, to keep an eye on the activities of rats and to collect data on them. It then transmits the previously collected data through a wireless network 760 or wired network 770 such as Internet or general telephone lines. The remote monitoring system also includes the central control unit 740, which analyzes and manages the transmitted data. The monitored subject site means a building where rats appears or is likely to appear, or any other predetermined spaces (e.g., public parks, places for loading freights, etc.), or an outer area of the building or the predetermined space.

The remote control unit 750, which is installed in each building 710, 720 and 730, monitors the activities of rats and collects data such as the population of rats invaded or captured, the invasion time, the invasion route and the invasion location (hereinafter, “pest control related information”).

The collected pest control related information is transmitted to the central control unit 740 in real time or periodically through the wireless communication network 760 or wired communication network 770. The communication network can be selected among a public switched telephone network, cables for high-speed Internet, and wireless local area network (LAN) according to the types and conditions of the sites 710, 720, and 730, in which the remote control unit 750 has been installed.

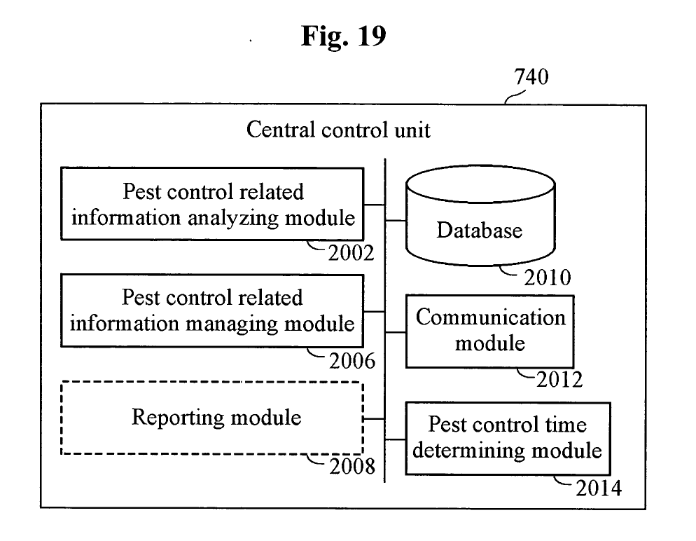

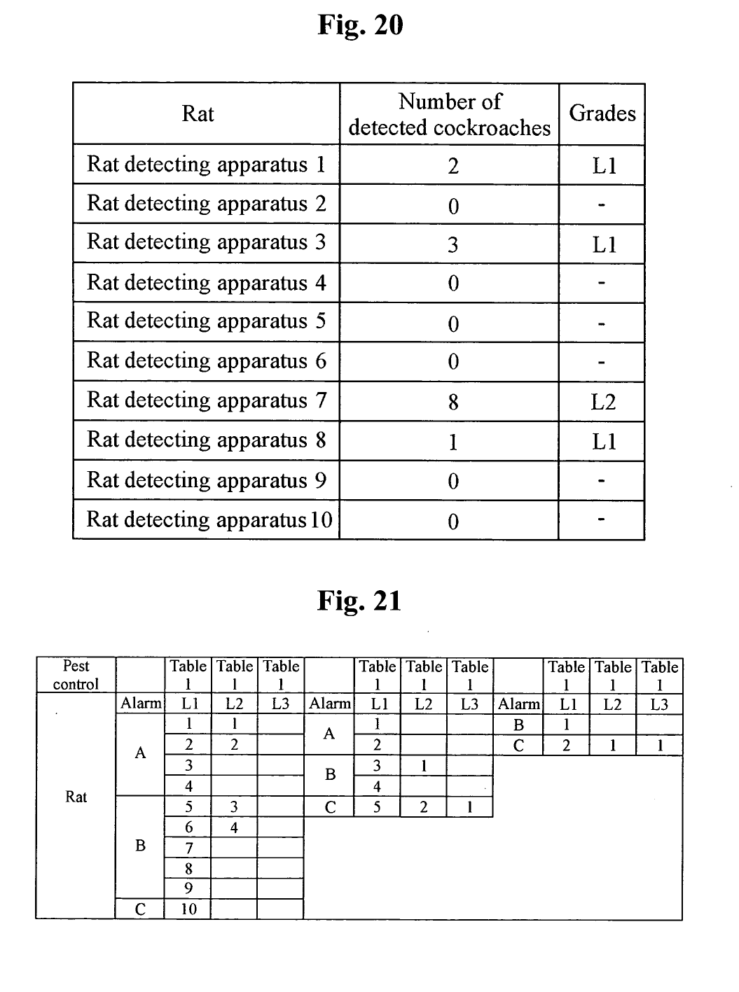

The central control unit 740 receives and analyzes the pest control related information transmitted from the remote control unit 750. Preferably, the pest control related information is analyzed to obtain information on, for example, the frequency of appearance and population of pest appearing or captured, based on predetermined analytic categories that are classified by buildings, positions in each building, times and dates, etc. Detailed descriptions on the analysis of the pest control related information will be made with reference to FIGS. 19 and 20. A pest control measure for each site is prepared based on the analyzed data in the central control unit 200. If it is decided that a pest control operation is required, then the service technician visits the subject site and performs the proper pest control operation based on the analyzed data.

The central control unit 740 generates secondary information, which is useful for pest control in, for example, appropriately determining a pest control time, by storing and updating the pest control related information in the database and analyzing it as needed. Hereinafter, the place at which the central control unit 740 is installed is called the “central control center.”

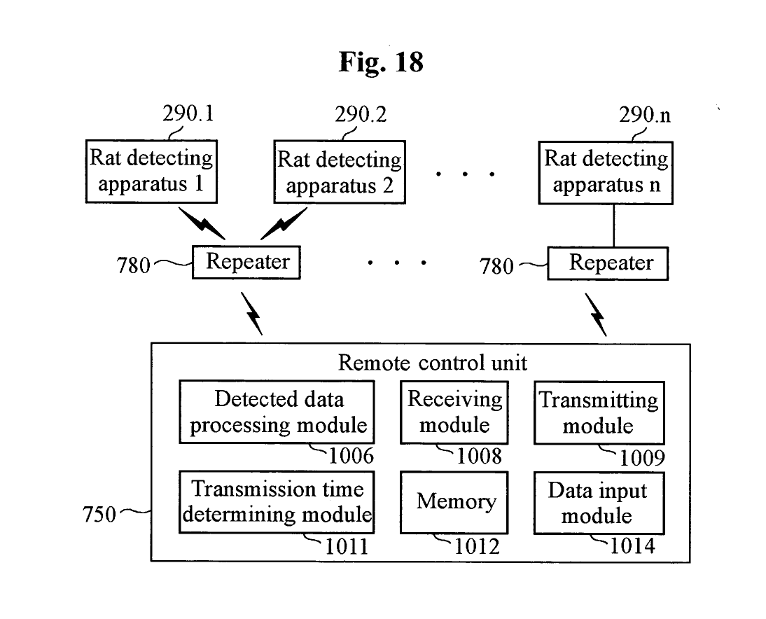

The interrelationship between the rat detecting apparatus 290, repeaters 780, the remote control unit 750 and the central control unit 740 is illustrated in FIG. 18. The repeaters 780 are provided for effectively conducting wireless communications between the rat detecting apparatus 290 and the remote control unit 750. Remote control unit 750 is configured such that a single repeater 780 is coupled to one or more rat detecting apparatuses 290 and remote control unit 750 is coupled to one or more repeaters 780. However, rat detecting apparatus 290 does not have to be connected to the remote control unit 750 through repeaters 780 but can be directly connected to the central control unit 750. Additionally, in the figures, it is shown that each rat detecting apparatus communicates with the repeaters 780. As explained earlier, if the rat detecting apparatus 290 with a controller is connected to several rat detecting apparatuses without the controller, then each of those apparatuses does not need to communicate directly with the repeaters 780, but may communicate with repeaters 780 through the detecting apparatus 290 with the controller.

In the present invention, to manage the pest control related information efficiently, a subject site in a remote place is sectioned into a plurality of sections. Sectioning herein means to hierarchically divide a subject site (including a building) into a plurality of sections according to the characteristics of the area. In one embodiment of the present invention, a four-stage sectioning is applied to a subject site. In the embodiment, the four-stage sectioning divides a subject site (e.g., an industrial complex as a whole) into: a large section including buildings in the industrial complex and their outer blocks; a floor section including each floor in the buildings; a middle section under the floor section; and a sub-section that is under the area of the middle section. The sub-section is a minimum unit of sectioning. However, if additional sections in the industrial complex need to be monitored, then the sub-section may be further sectioned. For example, as shown in FIG. 17, production buildings, warehouses, and outer blocks in a factory belong to the large sections; floors of the production buildings, such as 1^{st} basement, 1^{st} floor, 2^{nd} floor, 3^{rd} floor, and rooftop, belong to the floor group; production lines 1, 2 and 3 on each floor belong to the middle section; and a production department, a storage department, an aging room, and a lavatory in each of the production lines belong to the small section. Those sections are the fundamental units (typically, sub-sections are the minimum units for pest control) for pest control and pest control measures, and are used for analysis and management of pest control related information. For example, analyzing the progress of pest outbreak and effectiveness of pest control is performed on each production line belonging to the middle section to produce the pest control related information. An appropriate pest control measure and control equipment are prepared for each production line by using the pest control related information when reforming or increasing the production lines.

A sub-section code is assigned to each sub-section. Each facility in a remote place is classified and the sub-section codes are assigned thereto based on the functions of sub-sections and/or tendency of the pest outbreak thereof. If sub-section codes of different sub-sections are identical to each other, then a similar tendency of pest outbreak would be expected in such sub-sections. For sub-section in different middle or large sections, identical district codes may be assigned since the sub-section codes are classified by the functions of sub-sections. For example, even if a computer room and an office room in an office building belong to different middle sections, identical sub-section codes may be assigned to them because they have similar characteristics in terms of pest control. Thus, the pest control can be performed in a similar way. Further, even if sub-sections are of identical types different sub-section codes may be assigned to them by taking into account their middle sections, floor sections, and large sections. For example, although kitchens in a house and large-scale restaurant belong to an identical type of sub-sections, different sub-section codes may be assigned since the characteristics of the house and the large-scale restaurant are different. By using the sub-section code, one can easily find and understand the characteristics and functions of the sub-sections of a subject site and quickly establish an appropriate pest control measure, even when the pest control subject site has a complex structure.

In the embodiment of the present invention, a subject site is sectioned based on physical units of the building (such as floors and productions lines), but the criteria for sectioning in the present invention is not limited thereto. For example, a middle section of a subject site may be classified based on whether a wired or wireless communication system is suitable for the section. A department store, for example, has a first space including shops where there are many obstacles to a wireless communication, such as partitions for separating shops from each other, as well as a second space including a swimming pool and exercising machines where there is no obstacle for communication. Here, the middle sections for the first and second spaces are determined by the type of communication. Then, with reference to the determined middle sections, sensors for wired communication may be installed in the first space and sensors for wireless communication may be installed in the second space. The service technician can systematically install sensors required for each sub-section of the subject site based on the determined middle section of the site.

FIG. 18 shows a schematic block diagram of a remote control unit 750 in the remote monitoring system shown in FIG. 15.

As illustrated in FIG. 18 remote control unit rat detecting apparatuses 290, which are installed at predetermined positions of the subject site 710, 720, and 730, detect the movements of rats and provide detected data corresponding to the movements. The rat detecting apparatuses 290 are connected to the remote control unit 750 through repeaters. The remote control unit 750 receives detection signal from the rat detecting apparatus 290, processes the received data and transmits the processed signals through wired or wireless communication network. In other words, remote control unit 750 collects multiple detection signal transmitted from multiple rat detecting apparatuses 290 and appropriately processes the detection signals. It then transmits the processed signals to the central control unit in remote places. In FIG. 20, a solid line between the nth rat detecting apparatus 290 and repeater 780 represents the wired communication and lightening symbols indicate the wireless communication.

Using Radio Frequency Identification (RF ID), repeaters can recognize multiple rat detecting apparatuses 290. In this case, the communication unit of the data processor of the rat detecting apparatus 290 has the transponder of RF ID and the repeaters 780 have the reader of RF ID. The reader of the RF ID can recognize a large number of transponders even at long distances. Accordingly, by installing rat detecting apparatus 290 anywhere in the subject site, the rat detecting apparatus 290 is automatically recognized by the repeaters 780. In case numerous rat detecting apparatuses 290 are connected to numerous repeaters 780 and one repeater 780 has too many rat detecting apparatuses 290 connected thereto, then such repeater will become overloaded. Accordingly, an equal amount of rat detecting apparatuses 290 should be connected to each repeater. Specifically, a predetermined number of rat detecting apparatuses 290, which could be connected to one repeater 780, is decided beforehand and rat detecting apparatuses 290 beyond that number should be connected to other repeaters 780.

When the rat detecting apparatus 290 is displaced or in cases of communication difficulties, the rat detecting apparatus 290 saves the sensor identification the information and the rat detection result in a ring buffer for a certain period of time. It then transmits the saved data to repeaters 780 when the connection with repeaters 780 is resumed. In a structure where multiple rat detecting apparatuses are connected, as explained earlier, the controller is installed in only one or a small number of rat detecting apparatuses. Thus, the controller saves the detection signal of other connected rat detecting apparatuses and transmits data to repeaters 780.

Real time transmission of detection signal from the rat detecting apparatus 290 to the repeaters 780 or remote control unit 750 is most preferable. However, the transmission of detection signal could be delayed if too many rats enter/approach several different rat detecting apparatuses 290 at the same time, thus causing inaccuracy in understanding the frequency of rat appearance and preventing expeditious measures on the growth of rats. In the embodiment of the present invention, each rat detecting apparatus 290 is prioritized to solve the problems caused by the delayed transmission of data. For example, if the rat detecting apparatus is installed in the restroom, the kitchen or the hall of a restaurant, then sanitation becomes the most important factor. Therefore, a priority is given to the kitchen, the hall and the restroom in that order. If the repeaters 780 conclude that the rat detecting apparatuses 290 in different places are sending the detection signal at the same time, then the repeaters receive the detection signal in the order of priority of the rat detecting apparatus 290 rather than receiving the data in the transmitted order. In the above example, the detection signal from the rat detecting apparatus 290 in the kitchen is received with first priority, followed by the detection signal from rat detecting apparatus 290 in the hall, and then followed by the signal from the restroom. Although the detection signal from the rat detecting apparatus 290 in the restroom may be a little bit inaccurate, the kitchen can be kept with a high degree of sanitation.

The locations for installing the rat detecting apparatuses 290 and the number of rat detecting apparatuses 290 are determined by the ecology of rats in the subject site, as well as by the environment and location of the specific building. Further, the location for installing rat detecting apparatus 290 and the number of rat detecting apparatuses 290 may be determined based on the sub-section code assigned to the sub-sections of the pest control subject site.

According to the present invention, through sectioning the subject site, it becomes easy to manage the positions of rat detecting apparatuses 290 installed in each sub-section, as well as to analyze, utilize and maintain the pest control related information produced by the rat detecting apparatuses 290. Without sectioning, the service technician must identify the position of each rat detecting apparatus 290 on a drawing of the subject site or show the positions in an absolute or relative coordinate system, which can be quite complex. In the remote monitoring system in accordance with one embodiment of the present invention, the positions of rat detecting apparatuses 290 installed in the subject site may be identified and used with ease and accuracy since the locations are stored in the central control unit 740 together with data on the sections. Precise location of the rat detecting apparatus 290 can be identified through RF ID using GPS. The locations of rat detecting apparatuses 290 can be identified with GPS and such location data can be sent to the central control unit 740. The location data of rat detecting apparatus 290 in the central control unit is sent to the service technician's portable communication terminals such as PDA. On the PDA of the service technician, the blueprint of the monitored subject site is displayed and saved in graphic file and the location of rat detecting apparatus is marked. Thus, the service technician can easily find the location of rat detecting apparatus 290. If rat detecting apparatuses 290 are not easily located, then the service technician cannot obtain accurate rat related information. In addition, the birdlime or attractant food may be kept for a long time in the rat detecting apparatus without being replaced so that it becomes a cause of bad smell/germs.

In addition, in one embodiment of the present invention, due to the sectioning, the locations and the number of rat detecting apparatuses 290 installed in each sub-section, as well as the pest control related information, may be managed in relation to the sectioning information. Thus, the pest control related information can be managed and analyzed per sub-section. Therefore, useful information that is effective for pest control in each sub-section can be derived from the pest control related information.

The rat detecting apparatus 290 provides the detected data by detecting rat with the sensor and the controller. The detected data are transmitted to remote control unit 750 together with identification signal unique to each rat detecting apparatus 290, each sensor, time-stamp and rat count information through wired or wireless communication. As explained above, several rat detecting apparatuses are grouped and one of the multiple rat detecting apparatuses in the group has the controller, which can transmit data to remote control unit 750. In addition, even if there are several detecting apparatuses 290 with controller 270, each controller can be connected in a master-slave manner. In this case, data processed by the controller, which function as slaves under a master, is transmitted to remote control unit 750 through the master. As explained, various types of rat detecting apparatus can be used in various environment, and thus, the sensor identification signal may include signal for identifying characteristic and type of sensors.

The detected data may be transmitted from rat detecting apparatus 290 to remote control unit 750 through repeaters 780. Especially, the repeaters are necessary if the monitored subject sites 710, 720 and 730 occupy a wide area or have a complex structure. The appropriate number of repeaters 780 is determined based on the dimension of the monitored subject sites 710, 720 and 730 and the number of the rat detecting apparatuses 290, etc. Generally, installation of the system is easy if transmission of data is done through wireless communication among rat detecting apparatuses 290, repeaters 780 and remote control units 750. However, depending on the structure and the internal configuration of the monitored subject sites 710, 720 and 730 and the arrangements of the furniture and facility units, it may be preferable to install communication lines between repeaters 780 and nth rat detecting apparatus 290 for cost reasons.

The remote control unit 750 stores and processes the detected data received from rat detecting apparatus 290 and transmits them to central control unit 740. The remote control unit 750 is installed at selected positions of each building 710, 720 and 730 and the location of installation is decided by considering the type of communication (i.e., wireless or wired communication), the type and condition of each monitored subject sites 710, 720 and 730 and the distribution of rat detecting apparatuses 290. This is so that secure communications are guaranteed and the units are not subject to mechanical damage or breakdown.

As illustrated in FIG. 18 the remote control unit 750 includes functional modules such as a detected data processing module 1006, a receiving module 1008, a transmitting module 1009, a transmission time determining module 1011, a memory 1012 and a data input module 1014. Functions of the modules will be briefly explained below.

The receiving module 1008 receives the detected data from rat detecting apparatus 290 or repeaters 780 and transfers them to detected data processing module 1006. The detected data processing module 1006 processes the detected data and collects pest control related information. The pest control related information includes, for example, types and population of invaded or captured rat, invasion time, invasion path, and invasion position. Various data can be generated depending on the types and arrangement of rat detecting apparatuses 290. The processed pest control related information is sent to transmitting module 1009 and transmitting module 1009 transmits the processed pest control related information to the central control unit 740. The transmission time determining module 1011 determines whether to transmit the pest control related information to central control unit 740 periodically or in real time. The memory 1012 is used to store the pest control related information of the subject site. The data input module 1014 is provided for the service technician to manually input other pest control related information that is not detected by rat detecting apparatuses 290. Also, it may be used to revise the errors in the data of the rat detecting apparatus 290.

Hereinafter, the detailed explanations of the remote control unit will be provided below.

The detected data processing module 1006 of the remote control unit 750 processes detected data transmitted from respective rat detecting apparatus 290.1, 290.2 and 290.n based on the identification data of sensors and the time-stamp information that are transmitted together. The detected data processing module 1006 determines that a specific rat detecting apparatus 290 has failed and generates sensor failure signals indicating an abnormal status of the rat detecting apparatus 290 if detected data has not been received for a long time from the trap or the data over a predetermined range is received. The detected data processing module 1006 of the remote control unit 750 transforms the pest control related information into a format suitable for transmission to the central control unit 740. Also, the display such as LED can be installed in a rat detecting apparatus 290, which can indicate the status of the sensor and the data processor. Thus, it can indicate whether or not the rat detecting apparatus is broken by receiving failure signals from the detected data processing module 1006. The service technician does not have to disassemble a rat detecting apparatus 290 to find out whether the rat detecting apparatus 290 is broken. Such task can be done through confirming it on the display.

The transmitting module 1009 of the remote control unit 750 transmits the pest control related information or the failure signals to the central control unit 740 through wireless network 760 or wired network 770.

The transmission time determining module 1011 of the remote control unit 750 determines whether data transmission from the remote control unit 750 to the central control unit 740 should be done periodically (for example, on a certain time in the middle of the night) or on a real time basis. The types of rat monitored, as well as the types and conditions of the communication network and/or power supply used by the remote control unit 750, should be considered in deciding whether to transmit data periodically or in real time. In case of using public switched telephone network for wired communication 400, the data may be transmitted to central control unit 740 at night to minimize the interruption of daytime calls. Nevertheless, transmission time determining module 1011 of the remote control unit 750 may be set to transmit data immediately when rats appear in abnormal frequency. If the pest control related information is transmitted periodically, the data is stored in the memory 1012 for a predetermined period. The pest control related information may be classified by time period (e.g., period between 0 and 8 hours, 8 and 16 hours, and 16 and 24 hours) to be separately stored in memory 1012.

The data input module 1014 of the remote control unit 750 may be used by the service technician or a user of the monitored subject site to input other pest control related information that are not easily collected through the rat detecting apparatus 290. For example, when pest control is performed based only on the pest control related information collected through rat detecting apparatuses 290, the data from places without rat detecting apparatuses 290 cannot be obtained. In addition, the reliability of the information could be affected by incorrect data that has accumulated due to minor operation failures. The data input module 1014 solves the above problem by allowing a service technician or a user of the monitored subject site to input supplementary information. The supplementary information, such as the data collected from rat detecting apparatuses 290, is transmitted to the central control unit 740 through the transmitting module 1009.

The above-described function modules 1006, 1008, 1009, 1012 and 1014 of the remote control unit 750 may be implemented with hardware specifically designed to perform the above-explained functions, or software modules programmed to perform the functions in general hardware.

FIG. 19 is a block diagram conceptually showing the configuration of central control unit, which is included in the remote monitoring system of FIG. 15.

As illustrated therein, the central control unit 200 comprises pest control related information analyzing module 2002, pest control related information managing module 2006, a database 2010, communication module 2012, and pest control time determining module 2014. The pest control related information analyzing module 2002 receives the pest control related information transmitted periodically or in real time from remote control unit 750 and analyzes it. The pest control related information managing module 2006 stores, updates and manages the pest control related information in database 2010. The communication module 2012 performs wired/wireless communications. The pest control time determining module 2014 determines the time when rat control needs to be performed. The central control unit 740 may further comprise report-preparing module 2008 for preparing a report periodically or as needed with regard to the pest control related information (the report preparing module 2008 is depicted with a dotted line in FIG. 19 and is an optional component).

The pest control related information analyzing module 2002 receives the pest control related information through the communication module 2012 and analyzes the data according to various categories. More specifically, pest control related information analyzing module 2002 analyzes the pest control related information to obtain data (e.g., frequency of occurrence or invasion, the number of appearance and invasion of rats, etc.) by various categories (e.g., building, locations at which rat detecting apparatuses 290 are installed in each sub-section of a sectioned site, date and time, types of pest and sub-section codes) or various other criteria used for performing pest control.

For instance, the pest control related information classified by the sub-section code can be used to prepare a pest control measure with respect to a monitored subject site as follows. If monitored subject sites were a plurality of large-scale supermarkets each having similar structure, then such supermarkets would be comprised of similar sub-sections. In this case, an appropriate pest control measure may be obtained by comparing, among the large-scale supermarkets, the pest control related information of sub-sections having identical sub-sections code. For example, a service technician utilizes a relative value of pest appearance frequency for a particular sub-section code, as well as an absolute value of pest appearance frequency in each large-scale supermarket, to establish a pest control measure. For example, in case where the pest control related information of store sub-sections in two large-scale supermarkets A and B are similar but rats appear more frequently in a warehouse sub-section of supermarket A than in that of supermarket B, the service technician determines that a rat generating factor exists in the warehouse of large-scale supermarket A rather than that of supermarket B so that an additional pest control measure is required for large-scale supermarket A.

Meanwhile, in one embodiment of the present invention, the pest control related information analyzing module 2002 decides the grade for each rat detecting apparatus 290 (preferably in real time) based on the number of rats detected by each rat detecting apparatuses 290. For example, pest control related information analyzing module 2002 decides the grade of each rat detecting apparatus 290 as grade L1 when the number of detected rat is one to three, grade L2 when the number of detected rat is four to ten, and grade L3 when the number of detected rat is eleven to twenty. As the detected populations of rat increase, the grade of the rat detecting apparatus 290 also gets higher and after the pest control operation is performed, the grade of the rat detecting apparatus 290 is reset. Thus, the grade of each rat detecting apparatus 290 is useful for monitoring a status of pest appearance and determining whether or not an emergency pest control measure is required (detailed description will follow). In addition, the analyzed data from the pest control related information analyzing module 2002 may contain data such as previous history of rat appearance of each sub-section. With reference to historical data of rat, the service technician determines whether or not a new rat invasion path has appeared, and whether or not pest control chemicals are effective. Preferably, the categories used for analyzing the pest control related information are easily added or deleted, as needed.

The pest control related information managing module 2006 stores the pest control related information transmitted regularly or in real time from the remote control unit 750 in the database 2010. More specifically, the pest control related information managing module 2006 receives the pest control related information, which is newly transmitted from the remote control unit 750, and adds to or updates the existing data. Preferably, various analysis categories used by the pest control related information analyzing module 2002 are stored and managed in the database 2010.

The pest control time determining module 2014 determines whether the pest control is needed immediately based on the analyzed data of the pest control related information analyzing module 2002. The pest control time determining module 2014 notifies the service technician by alarm if the analyzed results of the pest control related information analyzing module 2002 are determined to be an emergency.

Referring to FIG. 20 through 22, a specific example of how the pest control time determining module 2014 utilizes the analyzed results (hereinafter, “analysis result”) from the pest control related information analyzing module 2002 will be explained below.

FIG. 20 is a table showing the analysis results of rats' activities in a sub-section.

Referring to the table in FIG. 20, the number of detected rats from each rat detecting apparatus 290 and grades assigned to each rat detecting apparatus 290 are shown as analysis results for each of the ten rat detecting apparatuses 290 installed in a sub-section. As seen from the table, the selected sub-section contains three L1-graded sensors (one to three rats detected) and one L2-graded sensor (four to ten rats detected). The analysis per each type of pest in each district is provided by pest control related information analyzing module 2002, preferably in real time.

Pest control time determining module 2014 determines the pest control time using the analysis results as follows:

FIG. 21 illustrates an example of a table used by the pest control time determining module 2013 for determining the time for pest control (“alarm table”);

FIG. 21 is a table, which illustrates how the alarm type (i.e., alarms A, B or C) is determined according to the number of rat detecting apparatuses of grade L1 and L2. The alarm type represents the seriousness of rat appearance in the each sub-section. In the embodiment of the invention, alarm A indicates that the service technician has to carefully perform periodic pest control operation, while alarms B and C indicate that the service technician must perform pest control operation immediately. Alternatively, the service technician may perform the pest control operation immediately in case alarm C occurs or in case alarm B occurs over a predetermined number of times within a certain period.

The type of alarm is determined by considering the type of sub-section where rats or other animal to be controlled appear, while alarm table may be changed depending on the characteristics of sub-section. The three tables shown in FIG. 21 are prepared to apply three different standards according to the type of sub-section. Table 1 of the alarm table in FIG. 21, for example, represents that alarm B applies if five to nine rat detecting apparatuses graded L1 are in the sub-section and alarm C applies if more than ten L1 or five L2 rat detecting apparatuses are in the sub-section.

In case there is one L1 grade rat detecting apparatus, alarm A applies according to table 1 of FIG. 21, whereas alarm B applies in table 3. Table 1 of FIG. 21 is applicable to the restroom or kitchen where the rat or other animal to be controlled is likely to appear at various times. Table 3 is applicable to the sub-sections, such as guestrooms of a hotel or a hospital ward, where appearance of rat causes serious consequences.

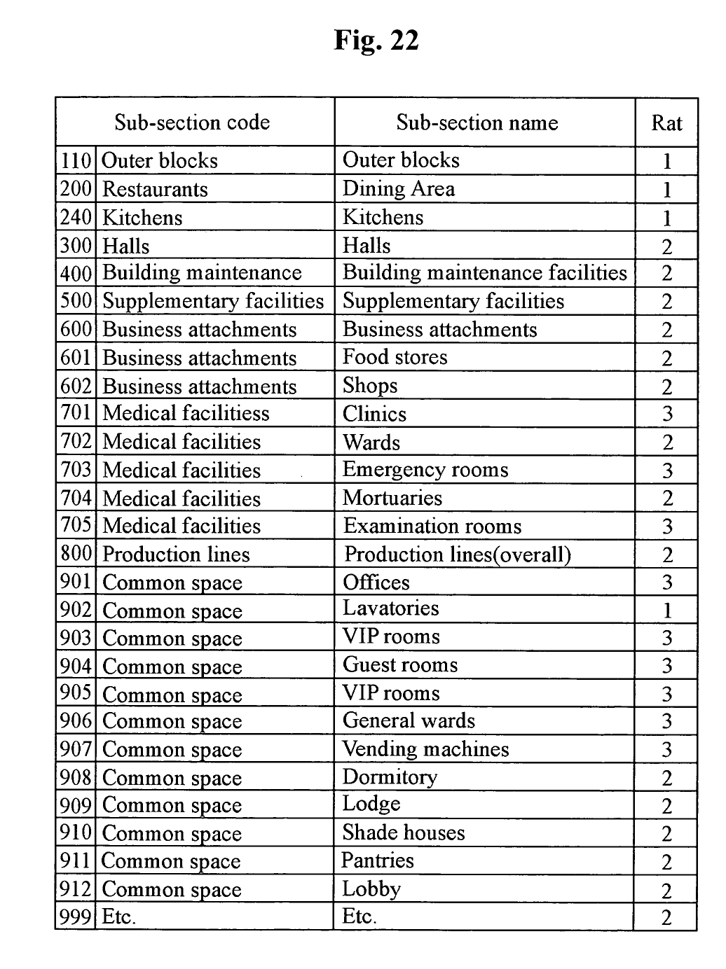

FIG. 22 is an application table for deciding which alarm table to apply according to the sub-section code (i.e., characteristics of the sub-section). The application table may be updated by considering the status of the monitored subject site to see whether it is subject to intensive monitoring, unique characteristics of sub-section, etc.

Hereinafter, an example of analysis conducted by the pest control related information analyzing module 2002 based on the location and rate of rat invasion, etc., will be explained in detail. For purposes of illustration, a monitored subject is limited to guestroom No. 1003 and an accompanying restroom on the 10^{th} floor of hotel A. In this case, the hotel A is a large section, the 10^{th} floor is a floor section, Room No. 1003 is a middle section, and the guest room and the restroom belong to a sub-section.

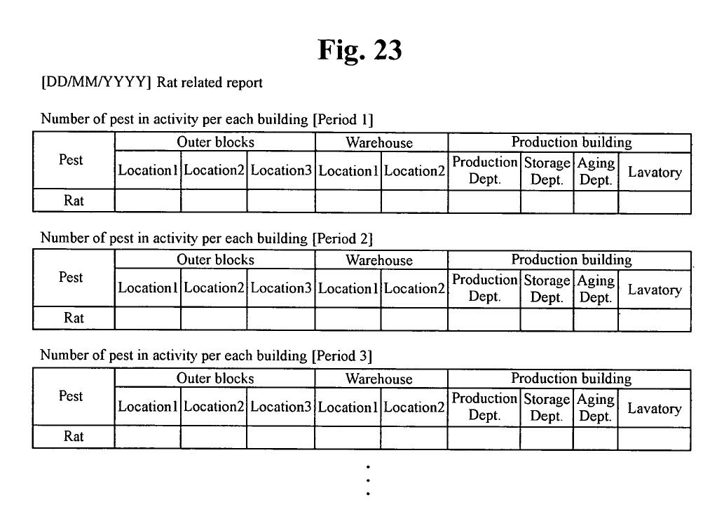

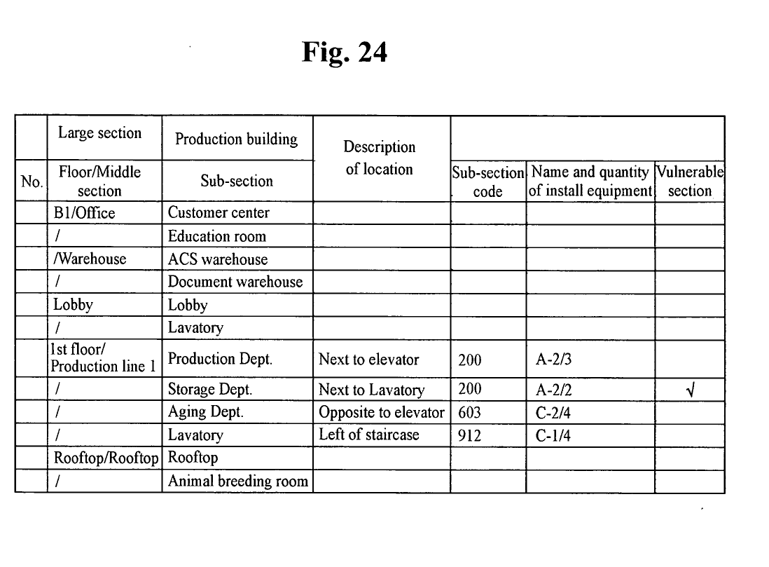

When fourteen rats appear in the guestroom No. 1003, four out of ten rat detecting apparatuses 290, which are installed at hotel A/10^{th} floor/Room 1003/guestroom, detect the rats and the pest control related information is transmitted to the central control unit. After that, the pest control related information is analyzed by the pest control related information analyzing module 2002 according to the locations where the rats appear and such analysis (shown in FIG. 20) is obtained for each rat detecting apparatus 290. In this case, the pest control related information analyzing module 2002 gives grade L1 to trap-1, trap-3 and trap-8, which detected 1 to 3 rats, and further gives grade L2 to trap-7 that detected 4 to 10 rats. With reference to the application table shown in FIG. 24, table 3 of FIG. 23 is applied to guestroom No. 1003. Since the number of traps having grade L2 is 1, alarm C is notified, in which the service technician then performs an immediate pest control.

If the analysis result of FIG. 20 is for a case in which the rats appear in the restroom (and not in the guest room), then table 1 is applied (refer to the application table of FIG. 21) such that alarm A is notified unlike the case of the guest room. Alarm A represents that, instead of immediate pest control, the service technician can perform careful periodic pest control operation.

However, if the pests appear frequently in the restroom (even in small numbers), an immediate pest control is required even in the restroom. In this case, the pest control time determining module 2014 utilizes the analysis result classified by an appearance frequency. For example, the pest control time determining module 2014 may be set to notify alarm B if the number of L1-graded traps is over three in a week. Therefore, in addition to the alarm table of FIG. 21, the pest control related information may be applied to various other tables to prepare for pest activity.

Next, the communication module 2012 in the central control unit 740 performs wired/wireless communication with receiving/transmitting module 1008 and 1009 of remote monitoring apparatus 100. Since the technologies for the wired/wireless communications are well known, a description thereof will be omitted herein.

Referring to the FIGS. 23 and 24, the reporting module 2008, which is optionally included in the central control unit 740, will be explained in detail. FIGS. 23 and 24 illustrate an embodiment of the report prepared by the reporting module 2008 in the central control unit 740.

As illustrated in FIG. 23, the reporting module 2008 prepares a pest control report at a predetermined time of the day based on the analysis result of the pest control related information analyzing module 2002. The pest report may contain the population (number) of detected pest per time period (i.e., Period 1, Period 2, Period 3, etc.) and the building 710, 720 and 730, etc. The preparation of pest control report is facilitated by classifying the pest related information by periods and buildings, and also by storing the pest control related information in remote control unit 750 or central control unit 740. The active number of rats in each building 710, 720 and 730 is once again classified by the installed location of rat detecting apparatus 290 and the number of captured rat detected by the trap is classified by the type and then recorded.

FIG. 23 illustrates an embodiment of a report containing information with respect to sub-sections of the monitored subject site (hereinafter, “sub-section report”). It is a report regarding the production building shown in FIG. 17 where four-tier sectioning is used.

The sub-section report is pre-stored in the central control unit 740 so that the service technician may easily perform pest control operation for each sub-section of the monitored subject. After completing the pest control operation, the sub-section report may be updated. The sub-section report shown in FIG. 23 contains data fields such as the name of the sub-section, the description of location, the sub-section code, the name and quantity of installed equipment and whether the sub-section is vulnerable. Large, floor, middle and sub-sections are shown in the second and third rows of the sub-section report and a brief description for the location of each district is provided on the description of the location column. (The location data enables the service technician to easily find each sub-section). The sub-section codes corresponding to the sub-sections are provided in the sub-section code field. In this embodiment, an identical sub-section code is assigned to a production department and a storage department. Therefore, identical equipments are provided to both departments. The name and quantity of equipment installed in each sub-section are provided in the equipment/quantity field. The vulnerable section field is marked in case that the frequency of rat appearance is higher than the predetermined level, or a district is vulnerable to rat or other animal to be controlled due to other reasons. By examining this district report, the service technician can easily understand the structure of the monitored subject. Further, the service technician can easily understand the status of the pest by using the sub-section report together with the pest control related information. Therefore, by using this type of report, the service technician easily obtains the necessary information without relying upon individual memory or experience. Accordingly, even if the service technician for a specific monitored subject site is changed, pest control may be effectively performed. Further, pest control is effectively performed even if a person not assigned to a specific site is sent to the site, as long as the person has basic skills in pest control. The report in this specification includes a report in hardcopy format, as well as a screen-display, an electronic file and an e-mail format.

By using these reports, the pest control related information, which is obtained from the rat detecting apparatus 290 installed in each sub-section, is systemically transmitted to the service technician. The service technician then examines the pest control related information of each sub-section to perform pest control operation.

Preferably, the reports are prepared using the analysis result of pest control related information analyzing module 2002. Such reports can be made periodically or as needed. Also, the reports are stored for a certain period of time and are statistically re-analyzed according to predetermined categories. More specifically, by storing and examining short-term reports accumulated over a long time (e.g., a month, a season or a year) to observe changes over time, one can obtain the secondary data. For example, if pest control related information in a pest control monitored subject site shows having a similar trend for a long time and indicates a slight increase in pest appearance over a long period of time, then we can guess that a factor relating to rat appearance exists in the site and has not been treated. Further, by examining the reports over a long time, the effects of change of structure of the monitored subject site or change of chemical for pest control on the pest activity may be observed. The pest control related information, which is analyzed over a short term, can be sampled or averaged by a week or a month so as to be used in deciding a long term trend.

By analyzing the pest control related information according to predetermined categories, one may obtain data such as where to install chemicals for pest control and the amount of necessary chemicals. Such information can also be included in the report. In this case, the service technician can simply place the chemicals in the monitored subject site based on the report. This is so that the burden of checking the location or the amount of chemicals may be reduced. The locations and amount of the chemicals may be determined based on the pest control related information (or secondary data derived from the pest control related information) from rat detecting apparatuses 290 by using a simple algebraic formula or by referencing a look-up table.

Further, in accordance with one embodiment of the present invention, the reports may contain activity information of rat, which is to be exterminated, at a position where a chemical is used (before and after installing the chemicals for exterminating the rat). The reports may be in the form of a graph where one can easily understand the trend. The reports are used to observe the effects of a chemical on a pest. In case there is no effect, the reports are used to determine whether the pests in the corresponding area have developed any tolerance to the chemicals used.

By using the sub-section report, the positions of rat detecting apparatus 290 and the pest control equipment installed in each district can be effectively managed. In the sub-section report, the type and quantity of the pest control equipment installed in each sub-section are represented. During pest control, the service technician takes proper measures to check as many equipment in each sub-section as identified in the sub-section report, as well as to eliminate the captured pests and to check the functions of the equipment.

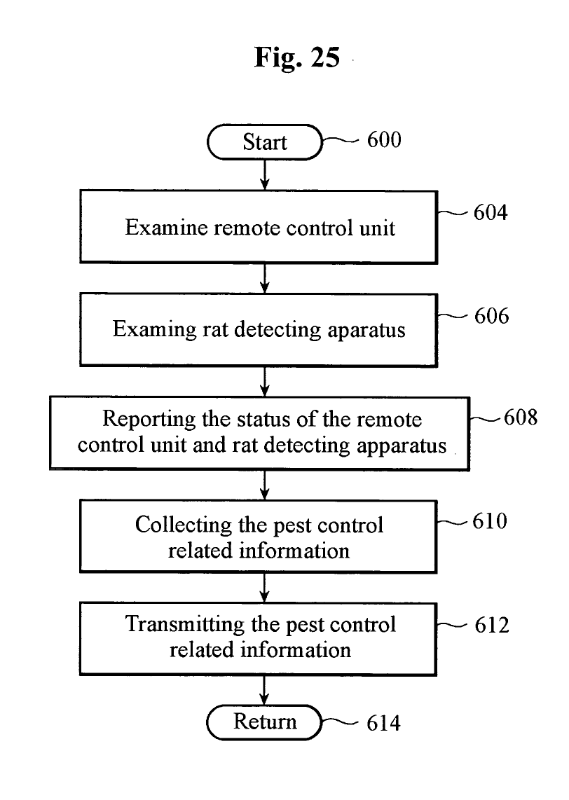

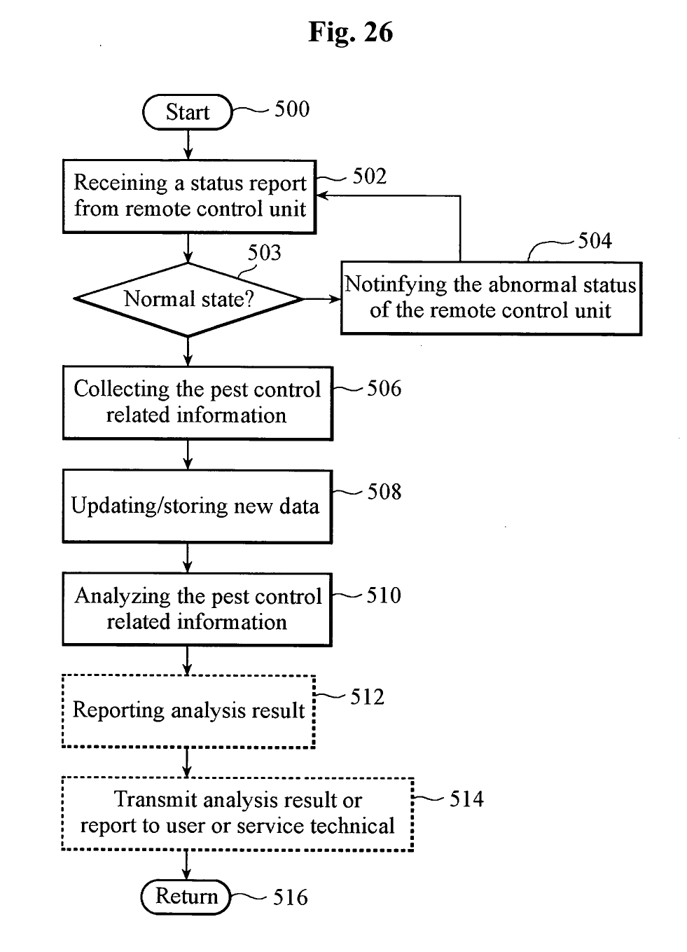

Referring to FIGS. 25 and 26, the operation of the remote monitoring system for pest control, which is in accordance with the embodiment of the present invention, will be explained below in detail.

First, the major operation of the remote control unit 750 will be explained in view of FIG. 25. FIG. 25 is a flow chart conceptually showing the major operations of the central control unit 750 in the remote monitoring system for pest control (shown in FIG. 15).

As illustrated therein, electrical power is applied in order to start the operation (step 600) and the components, such as remote control unit 750 and rat detecting apparatuses 290, are examined (steps 604 and 606). As a result, the status of the remote control unit 750 and the rat detecting apparatuses 290 are transmitted and reported to the central control unit 740 (step 608). Through such step of status reporting, the central control unit 740 becomes ready to communicate with the remote control unit 750. Preferably, step 608 is regularly performed to periodically check the status of the remote control unit 750 by the central control unit 740, as well as when the electrical power is applied.

Then, the remote control unit 750 receives the detected data from each rat detecting apparatus 290 to collect the pest control related information (step 610). It then transmits the collected pest control related information to the central control unit 740 (step 612).

The control process of the above remote control unit 750 returns to an appropriate step among the previously explained. The above-mentioned steps do not have to be performed sequentially. Also, from power-on to power-off, all the steps do not have to be repeated the same number of times.

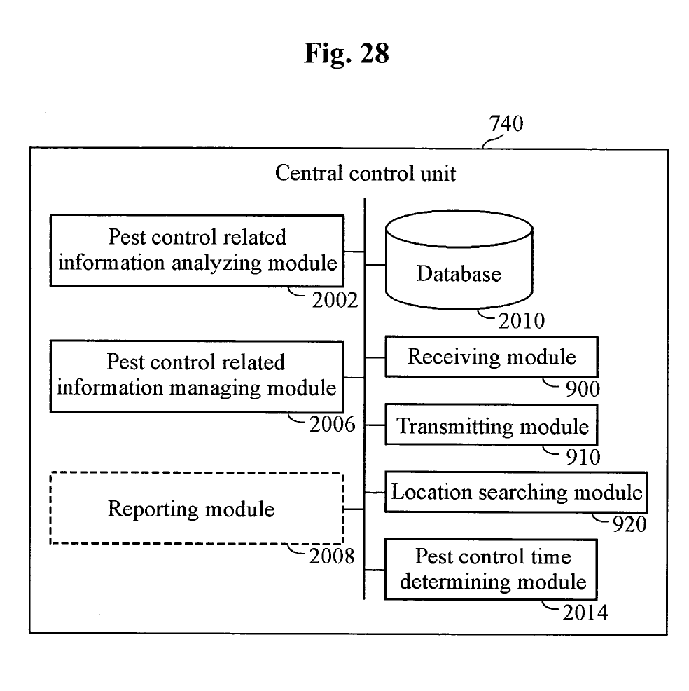

The major operations of the central control unit 740 will now be explained in view of FIG. 28. FIG. 28 is a flow chart conceptually showing the major movement of the remote monitoring system for pest control (shown in FIG. 17).

As illustrated therein, electrical power is applied in order to start the operation in step 500. The central control unit 740 receives a status report from the remote control unit 750, which represents whether or not the remote control unit 750 and rat detecting apparatus 290 are in a normal state (step 502). If it is confirmed that the components of the remote control unit 750 are in the normal state, then next steps are performed. However, if the conditions of the rat detecting apparatus 290 of the remote control unit 750 or the remote control unit 750 are determined to be abnormal, then such information is notified to the service technician (step 504). The service technician, for instance, should immediately repair the apparatus if the rat detecting apparatus 290 in important sections, such as a hotel or a guestroom, is out of order. The failed rat detecting apparatuses 290 in sections, such as restrooms, can be repaired during regular check-ups. To obtain reliable response, the remote control unit 750 may report the failure of rat detecting apparatuses 290 to the service technician after receiving a failure response of the traps (e.g., three times).

Next, the central control unit 740 receives the pest control related information transmitted from the remote control unit 750 (step 506). To receive the pest control related information reliably, the communication module 2012 has to be examined first. Such a step is well known to a person of ordinary skill in the art. Therefore, the detailed descriptions will be omitted herein.

After the above, the central control unit 740 performs database management operation by comparing the received pest control related information with the pre-stored data in the database 2010. It then updates or stores the new data as needed (step 508).

Subsequently, the central control unit 740 analyzes the pest control related information stored or updated in the database 2010 based on predetermined categories for analysis (step 510). Preferably, analysis of the pest control related information is performed to find information such as the frequency of appearance or invasion, as well as the number of appearing or invading rats based on various categories (e.g., each building where remote monitoring apparatus 100 are installed, the positions of rat detecting apparatus 290 in each building or specific times of the day.

Optionally, the central control unit 200 may produce a report containing the analysis result of the pest control related information (step 512). The details of the report will be omitted herein since it has already been explained in view of FIGS. 23 and 24. The central control unit 200 transmits the analysis result or the report to a user or a service technician of each site 710, 720 and 730 (step 514). Step 514 is also an optional step.

After the above, control process of the central control unit 740 is returned to an appropriate step among the previously explained steps.

The above steps do not need to be performed sequentially or repeated the same number of times from power-on to power-off.

The following describes a remote monitoring system of another embodiment of the present invention.

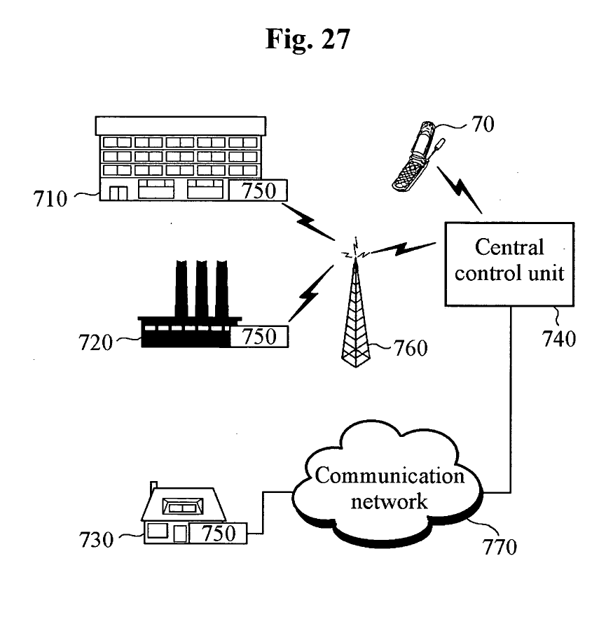

FIG. 27 is a diagram chart conceptually showing the remote monitoring system for pest control according to the second embodiment.

The difference between the first and second embodiments of the remote monitoring system of the present invention is that the central control unit 740 re-transmits the analysis result of the pest control related information to users of each building 710, 720 and 730 and/or to the service technician. More specifically, the service technician receives the analysis result of the pest control related information by using mobile communication terminal 70, such as a personal digital assistant (PDA) or a mobile phone, and performs pest control operation that is suitable for each monitored subject site.

FIG. 28 is a block diagram showing the central control unit 740 according to the second embodiment of the present invention.

The second embodiment comprises a receiving module 900 and a transmitting module 910 instead of the communication module of the first embodiment. Also, the central control unit 740 may optionally include a location searching module 920.

In the second embodiment, the receiving module 900 receives pest control related information from the remote control unit 750 and transmits the data to pest control related information analyzing module 2002. An analysis result is transmitted from pest control related information analyzing module 2002 to mobile communication terminal 70 of the service technician through transmitting module 910 of central control unit 740. The pest control related information is transmitted to the service technician periodically, or in response to the service technician's demand, or according to other predetermined transmission protocols. For example, in case the service technician is scheduled to visit a subject site, the pest control related information of the subject sites to be visited on a particular day is transmitted to mobile communication terminal 70 of the service technician on the basis of the visiting schedule. In this embodiment, in cases of an emergency situation in a subject site, central control unit 740 searches the locations of service technicians possessing mobile communication terminal 70 through the location searching module 920 and transmits pest control related information to the service technician located nearest to that building where emergency happened. The location searching module 920 may receive location information of mobile communication terminal 70 (whenever necessary) through communication providers.

In addition, by using mobile communication terminal 70 and location searching module 920, the paths or movements of service technicians may be effectively managed. For example, since central control unit 740 detects the location of each service technician through mobile communication terminal 70, the order of visits for pest control may be effectively determined. If the workflow of pest control is determined so that the technician can first take care of the closest site, the time required to travel to the sites can be reduced, thus increasing the efficiency of pest control operation.

In accordance with the second embodiment of the present invention, the length of time from when the emergency occurs to when the pest control is performed may be shortened. Generally, central control unit 740 is connected to a plurality of remote monitoring apparatuses 100 through wired or wireless communications. Thus, some remote monitoring apparatuses 100 may be located somewhat far from the central control unit 740. If the service technician at the central control center receives an analysis of pest control related information from central control unit 740 and then goes to a remote pest control subject site, it requires much time. According to the second embodiment of the present invention, the analysis result is automatically transmitted to a service technician nearest to the site where many rats appeared (meaning emergency). This is so that the service technician can immediately exterminate the rats. Since the service technician can check other pest control related information on the way to the subject site, he/she may perform a regular examination and other pest control operation when exterminating the rats.

FIG. 28 is a block diagram conceptually showing the third embodiment of the remote monitoring system.

The difference between the second and third embodiments of the present invention is that pest control related information may be directly transmitted from remote control unit 750 to mobile communication terminal 70 in the third embodiment. Although mobile communication terminal 70 shown in FIG. 28 communicates with remote control unit 750 by wireless communication, mobile communication terminal 70 can also be configured to communicate with the remote control unit 750 via both wired and wireless communications. In the third embodiment of the present invention, the service technician may receive an instruction to move to a subject site from the remote control unit 750, which is installed at the site, or from the central control unit 740. He/she can also receive pest control related information from both.

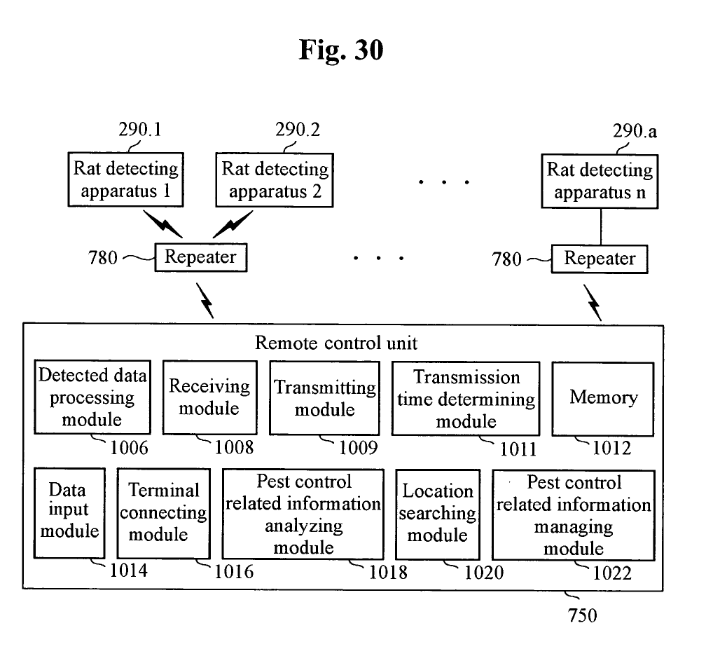

FIG. 30 is a block diagram conceptually showing the remote control unit 750 according to the third embodiment.

Compared to the first embodiment, the remote control unit 750 of the third embodiment further includes a pest control related information analyzing module 1018, a pest control related information managing module 1022, and a terminal connecting module 1016. Also, a location searching module 1020 may be optionally added to remote control unit 750.

The location searching module 1020 installed in the remote control unit 750 searches the location of the mobile communication terminal 70. The detailed analysis of information is performed in pest control related information analyzing module 1018 in remote monitoring apparatus 100. The procedure for analyzing information in the pest control related information analyzing module 1018 is identical to that of the central control unit 740. An analysis is stored in memory 1012 by the pest control related information managing module 1022. A service technician receives an instruction to go to a subject site through mobile communication terminal 70. At the site, the service technician then connects the mobile communication terminal 70 to the terminal connecting module 1016 of the remote control unit 750 by wired/wireless communication. When the mobile communication terminal 70 is connected to the terminal connecting module 1016, the terminal connecting module 1016 retrieves the analysis result of the pest control related information stored in the memory 1012 and transmits the same to the mobile communication terminal 70. The service technician performs pest control on the basis of the analysis result received through mobile communication terminal 70. In accordance with the third embodiment of the present invention, the remote control unit 750 may comprise a reporting module (not shown) so as to transmit a report, which is produced by the reporting module, to the mobile communication terminal 70 through the terminal connecting module 1016. For example, after checking the report, which includes the information on sections of a site through the display of mobile communication terminal 70, the service technician performs pest control suitable for the structure of the site.

In the third embodiment of the present invention, most of the data is directly transmitted from the remote control unit 750 to the mobile communication terminal 70 without using a commercial wireless communication service. As a result, the costs for wireless communication may be reduced.

Similar to the second embodiment, the location searching module 1020 may be employed in the third embodiment of the present invention for searching the location of a service technician nearest to the subject site. Further, when an emergency occurs, an instruction to move to a subject site is directly transmitted from the remote control unit 750 to the mobile communication terminal 70 of a service technician, who is closest to the subject site.

The procedures of pest control will be explained by using the above-explained remote monitoring system of the present invention.

When alarm C is issued for a monitored subject site in the central control center, the service technician refers to the report in order to understand the environment of the building that is in need of pest control. The service technician sends the departure signal to the remote control unit by using a PDA before going to the monitored subject site. When arriving at the subject site, he/she connects the PDA to the terminal connecting module of the remote control unit to receive the pest control related information regarding any changes in the circumstances. The arriving time at the monitored subject site is transmitted to the remote control unit and the central control unit. The service technician performs the work by conversing with the user of the monitored subject about the problems and receives additional demands from the user, which are transmitted to the central control unit through PDA. The service technician performs the rat detecting apparatus check-up, the replacement of birdlime, the chemical treatment, etc. After everything is done, the rat detecting apparatus is reset so that the counted population of the rats is set to zero. When everything is done, he/she connects his/her PDA to the terminal connecting module of the remote control unit in order to confirm the situation. The day's work is done when the service technician explains the situation to the user of the building using the PDA. The service technician, who is done with the pest control, moves to another monitored subject site according to the instructions from the central control center. In order to move quickly to the subject site, a relatively short route to the monitored subject should be selected by using the data received by the PDA from the center.

Although the analysis of the pest control related information is performed in remote control unit 750 in the embodiment explained above, the mobile communication terminal 70 can be configured to analyze the pest control related information by adding a program or separating hardware to mobile communication terminal 70. That is, the mobile communication terminal 70 may comprise a pest control related information analyzing module. The procedure to be performed in the mobile communication terminal 70 is similar to that of the central control unit 200.

According to the second and third embodiments of the present invention, a service technician, who is closest to a monitored subject site, may perform pest control. Conventionally, each service technician is assigned to a corresponding monitored subject site so that only the assigned service technician performs a pest control in the corresponding monitored subject site. As a result, if the service technician for a specific monitored subject site is switched or replaced, effective pest control on that site becomes difficult since a new service technician has no systematic data on the subject site. However, in the second and third embodiments of the present invention, service technicians obtain analyzed pest control related information on a monitored subject site from the central control unit 200 or remote monitoring apparatus 100 while moving to the subject site. This is so that any service technicians may effectively perform pest control.

### INDUSTRIAL APPLICABILITY

The present invention has the following effects.

First, it is possible to accurately analyze the statistics regarding rat appearance so that pest control can be performed at an appropriate time.

Second, by installing the sensor in the rat detecting apparatus, the service technician can know whether a rat is captured, the number of captured rats, and whether birdlime needs to be replaced from a remote place without visiting the building where the rat detecting apparatus is installed such that human resources can be saved or mitigated. Thus, the service technicians only visit the site when there is an abnormal frequency of rat invasion or birdlime replacement is required.

While the present invention has been shown and described with respect to the particular embodiments, those skilled in the art will recognize that many changes and modifications may be made without departing from the scope of the invention as defined in the appended claims. For example, the rat detecting apparatus according to the embodiment of the present invention not only can be modified to various forms but also can be combined with other various detecting apparatuses.

What is claimed:

1. A rat detecting apparatus, comprising:
a stick-shaped member sized and configured to be located at the corner of a building; and
a plurality of sensors installed on the stick-shaped member.

2. The rat detecting apparatus of claim 1, wherein the stick-shaped member comprises two or more unit modules each having at least one sensor attached thereon.

3. A rat detecting apparatus, comprising:
a stick-shaped member projecting from a wall of a building; and
a plurality of sensors installed on the stick-shaped member.

4. The rat detecting apparatus of claim 2, wherein the stick-shaped member comprises two or more unit modules each having at least one sensor attached thereon.

5. A rat detecting apparatus, comprising:
a dome-shaped member sized and configured to be attached to a ceiling of a building; and
a plurality of sensors installed on the dome-shaped member.

6. A rat detecting apparatus, comprising:
a sensor attached to a lower end of a wall of a building, the sensor being sized and configured to face downward and detect objects passing on a floor.
